(19) United States
(12) Patent Application Publication
(10) Pub. No.: US 2014/0164869 A1
(43) Pub. Date: Jun. 12, 2014

(54) EFFICIENT DATA-STORAGE DEVICES THAT INCLUDE MEMORY ELEMENTS CHARACTERIZED BY POTENTIALLY LARGE SWITCHING LATENCIES

(71) Applicants: Erik Ordentlich, San Jose, CA (US); Gadiel Seroussi, Cupertino, CA (US)

(72) Inventors: Erik Ordentlich, San Jose, CA (US); Gadiel Seroussi, Cupertino, CA (US)

(21) Appl. No.: 14/233,121

(22) PCT Filed: Jul. 27, 2011
(86) PCT No.: PCT/US2011/045549

§ 371 Date: Jan. 15, 2014

(51) Int. Cl. G06F 11/10

(52) U.S. Cl. CPC G06F 11/10
USPC 714/763

(57) ABSTRACT

One example disclosed in the application is an electronic data-storage device comprising one or more arrays of memory elements that each includes a data-storage medium that is switched between two different states by application of a switching-inducing force or gradient to the data-storage medium, a top control element and a bottom control element through which the switching-inducing force or gradient is applied, and a feedback signal. The data-storage device also includes an error-control-coding encoder that encodes received data and a READ/WRITE controller that writes encoded data received from the error-control-coding encoder to a number of memory elements by applying the switching-inducing force to the one or mare arrays of memory elements until feedback signals indicate that the WRITE operation has completed or until the switching-inducing force or gradient has been applied for a maximum application time.

### TECHNICAL FIELD

The present application is related to devices that store data in non-linear data-storage materials, including memristive data-storage materials, and, in particular, to a method and system for ameliorating the effects of potentially long switching times of memory elements that include the non-linear data-storage materials.

### BACKGROUND

The dimensions of electronic circuit elements have decreased rapidly over the past half century. Familiar circuit elements, including resistors, capacitors, inductors, diodes, and transistors that were once macroscale devices soldered by hand into macroscale circuits are now fabricated at sub-microscale dimensions within integrated circuits. Photolithography-based semiconductor manufacturing techniques can produce integrated circuits with tens of millions of circuit elements per square centimeter. The steady decrease in size of circuit elements and increase in the component densities of integrated circuits have enabled a rapid increase in clock speeds at which integrated circuits can be operated as well as enormous increases in the functionalities, computational bandwidths, data-storage capacities, and efficiency of operation of integrated circuits and integrated-circuit-based electronic devices.

Unfortunately, physical limits to further increases in the densities of components within integrated-circuits manufactured using photolithography methods are being approached. Ultimately, photolithography methods are constrained by the wave length of radiation passed through photolithography masks to fix and etch photoresist. Furthermore, as dimensions of circuit lines and components decrease further into nanoscale dimensions, current leakage through tunneling and power-losses due to relatively high resistances of nanoscale components are providing challenges with respect to further decreasing component sizes and increasing component densities by traditional integrated-circuit-manufacturing and design methodologies.

The challenges to increasing circuit densities have spawned entirely new approaches to the design and manufacture of nanoscale circuitry and circuit elements. Research and development efforts are currently being expended to create extremely dense, nanoscale electronic circuitry through self-assembly of nanoscale components, nanoscale imprinting, and other relatively new methods. In addition, new types of circuit elements that operate at nanoscale dimensions have been discovered, including memristive switching materials that can be employed as bistable nanoscale memory elements. Unfortunately, memristive switching materials, and other candidate bistable-memory-element materials, which feature non-linear responses to applied voltage, temperature, and other forces and gradients that are applied to change the state of the materials, often exhibit relatively broadly distributed, asymmetrical probability density functions (“PDFs”) that characterize the probabilities that a memory element switches with respect to different durations of time that the switching force or gradient is applied. The asymmetrical PDF may feature a relatively long tail, corresponding to the fact that the force or gradient may need to be applied for a significantly greater period of time, to ensure switching, than the average time needed for switching. Alternatively, the PDF characterizes the switching behaviors of a large number of memory elements, with the long tail corresponding to a small fraction of the large number of memory elements which switch at significantly longer durations of application of the force or gradient than the majority of the large number of memory elements. This fact, in turn, entails significantly decreased operational bandwidths and/or reliability with respect to theoretical devices with narrowly distributed, symmetrical PDFs, for which the time that a force or gradient needs to be applied in order to ensure switching up to a probability corresponding to a maximum tolerable bit error rate is not significantly greater than the average application time at which switching occurs. Theoreticians, designers, and developers of memory devices and other data-storage devices based on non-linear data-storage materials, such as memristive materials, continue to seek methods and device architectures that ameliorate the asymmetrical, broadly-distributed switching-time characteristics of certain of these devices.

### BRIEF DESCRIPTION OF THE DRAWINGS

FIGS. 1A-B illustrate an example nanoscale single-bit data-storage device that features two stable electronic states.

FIG. 2 shows current versus voltage behavior of the bistable nanoscale electronic device illustrated in FIGS. 1A-B.

FIG. 3A illustrates a log-normal probability density function (“PDF”).

FIG. 3B shows the corresponding cumulative distribution function (“CDF”) for the log-normal distribution PDF shown in FIG. 3A.

FIG. 4 illustrates a first of the two approaches for ameliorating the effects of log-normal distribution of switching times, memristive memory elements, and other non-linear data-storage materials.

FIG. 5 illustrates a second approach to ameliorating the effects of log-normal distributed switching times for memristive memory elements and other bistable data-storage materials.

FIGS. 6A-B illustrate application of a switching pulse to a memristive memory element, or other non-linear data-storage material.

FIGS. 7A-F illustrate six different data-writing methods for writing data to a memory device that includes memory elements characterized by log-normally distributed switching times.

FIG. 8 illustrates the dependence of the total expected time of application of a WRITE voltage, T_{avg}, on the length of the first pulse, T₁, in a two-pulse WRITE method.

FIG. 9 illustrates the dependence of she expected cumulative time of application of a WRITE voltage, T_{avg}, on the maximum application time Tₘₐₓ for a continuous WRITE method.

FIG. 10 provides a table showing comparisons of s number of different WRITE methods for writing data into a memory that includes memory elements characterized by log-normally distributed switching times.

FIG. 11 graphically illustrates data from the first horizontal section of the table provided in FIG. 10.

FIG. 12 provides a table that lists the maximum number of pulses and average number of pulses for multi-pulse WRITE methods that achieve desired switching-failure probabilities for considered READ times that are various different fractions of τ.

FIG. 13 shows a graph of expected wait times with respect, to WRITE inter-arrival times for an uncoded, two-pulse write method and a coded two-pulse WRITE method.

FIG. 14 illustrates a data-storage device that incorporates both feedback signals and ECC encoding.

FIG. 15 provides a control-flow diagram that illustrates operation of the READ/WRITE controller (1430 in FIG. 14).

FIG. 16 provides a control-flow diagram for the routine “WRITE” (1506 in FIG. 15).

### DETAILED DESCRIPTION

The present application is directed to electronic data-storage devices that store data in memory elements characterized by relatively broad and/or asymmetric switching-time probability density functions. These types of memory elements, many of which incorporate non-linear, bistable materials, including memristive materials, may exhibit worst-case switching times that are significantly larger than average switching times. The probability distributions reflect the switching times observed when a memory element is repeatedly switched from a first bistable state to a second bistable state. The probability distributions also reflect the observed switching times of a large number of individual memory elements when a switching voltage, current, or other force or gradient is applied to the large number of memory elements. The potentially lengthy switching times result, for conventional data-storage devices, in relatively long switching cycles and correspondingly low data-storage-input bandwidths.

The electronic data-storage devices to which the current application is directed are discussed below in six subsections: (1) Overview of Memory Elements with Asymmetrically-Distributed Switching Times; (2) Error Control Coding; (3) Hypothetical WRITE methods; (4) Analysis of the Various WRITE Methods: (5) Results of the Analysis of the Various WRITE Methods; and (6) Examples of Electronic Data-Storage Devices to which the Current Application is Directed.

### Overview of Memory Elements with Asymmetrically-Distributed Switching Times

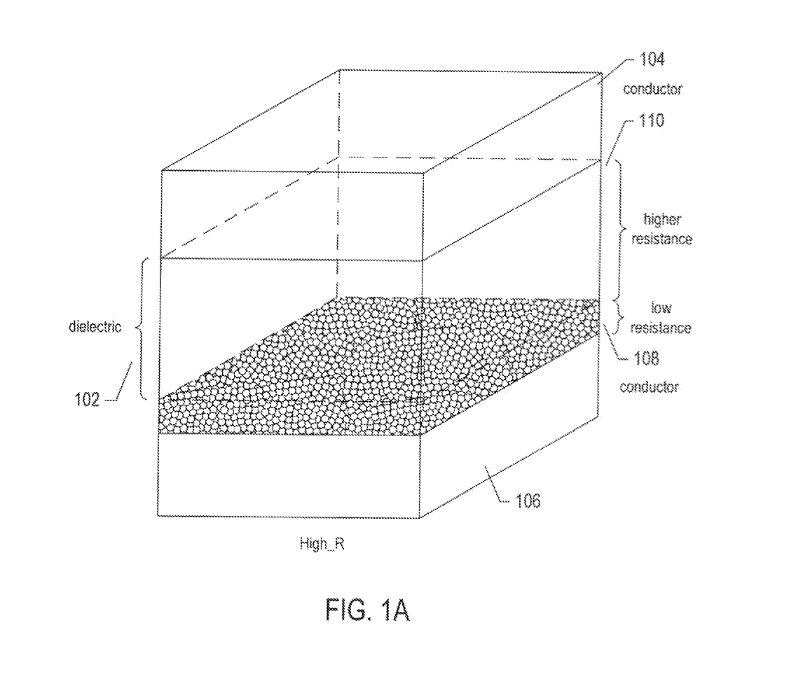

FIGS. 1A-B illustrate an example nanoscale single-bit data-storage device that features two stable electronic states. FIG. 1A shows the device in a relatively high-resistance state and FIG. 1B shows the device in a relatively low-resistance state. The resistivity of a dielectric material between electrodes can be electronically sensed, and thus the two different resistance states shown in FIGS. 1A-B can be used to store a single bit of information.

FIGS. 1A-B both use the same illustration conventions. In FIG. 1A, a dielectric material 102 is sandwiched between two conductive electrodes 104 and 106. Those portions of the electrodes overlying and underlying the bistable dielectric material 102 are shown in FIG. 1A. In general, the electrodes may be nanowires or other conductive elements that electrically interconnect the nanoscale electronic device with other nanoscale electronic devices, nanoscale circuitry, and, ultimately, microscale and macroscale circuitry. In FIG. 1, the dielectric material 102 is shown to have two different portions; (1) a low-resistivity portion 108 and a higher-resistivity portion 110. The low-resistivity portion is a depletion region that includes, as one example, oxygen vacancies that facilitate current conduction. The higher-resistivity portion 110 of the dielectric material lacks the vacancies, and thus has the conductance of an undoped semiconductor or dielectric substance. When a sufficiently large-magnitude voltage is applied across the dielectric material in an upward vertical direction, or z direction, in FIGS. 1A-B, the oxygen vacancies can be redistributed within the dielectric material between the two electrodes as shown in FIG. 1B. Redistribution of the oxygen vacancies results in the dielectric material having a relatively low resistance throughout. Applying a sufficiently large voltage in the opposite direction, or negative voltage in the upward, vertical direction in FIG. 1B, results in forcing the vacancies to distribute themselves nearer to the lower electrode, as in FIG. 1A.

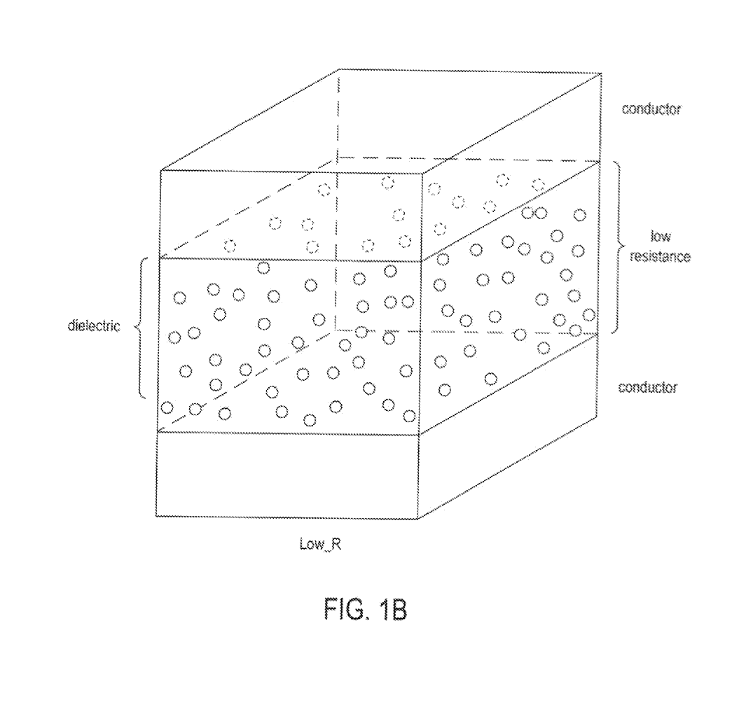

FIG. 2 shows current versus voltage behavior of the bistable nanoscale electronic device illustrated in FIGS. 1A-B. The portion of the I-V curve with relatively large slope 202 is the portion of the I-V curve corresponding to the low-resistance state of the nanoscale electronic device, illustrated in FIG. 1B. The slope of this curve is proportional to the conductivity and inversely proportional to the resistivity of the dielectric material between the two electrodes. The portion of the I-V curve with a small-magnitude slope 204 corresponds to the high-resistance state of the nanoscale electronic device shown in FIG. 1A. Beginning at the origin 206 of the voltage 208 and current 210 axes, and assuming that the nanoscale electronic device is in the high-resistance state shown in FIG. 1A, application of increasing positive voltage from the lower electrode to the upper electrode results in a very small increase in current across the dielectric material, as represented by the right-hand portion of the I-V curve 204, until the applied positive voltage nears the voltage V_{w}⁺ 212, at which point the oxygen vacancies are rapidly redistributed throughout the dielectric or semi-conductive material, as a result of which the current rapidly increases, as represented by the nearly vertical portion of the I-V curve 214, until the portion of the I-V curve representing the low-resistance state is reached at point 216. Further increase in the positive voltage results in a relatively large, corresponding increase in current, along the far right portion of the low-resistance-state I-V curve 220 until a voltage V_{D}⁺ 222 is reached, at which point the device fails due to generation of excessive amounts of heat as a result of resistive heating by the high current passing through the device. Once the low-resistance state is reached, at point 216, then as the voltage applied across the electrodes is decreased, the low-resistance-state I-V curve 202 is followed leftward, descending back to the origin 206, and, as voltage is further decreased to negative voltages of increasing magnitude, the current switches in direction and increases in magnitude to point 224, at which point oxygen vacancies are again redistributed back to a dense layer near the lower electrode, as shown in FIG. 1A, leading to a rapid decrease in the magnitude of the current flowing through the device and a return to the high-resistance state at point 226. Further increase in the magnitude of the negative voltage applied across the device eventually leads to the voltage V_{D}⁻ 230, at which point the device again fails due to resistive heating.

The voltage at which the nanoscale electronic device transitions front the low-resistance state to the high-resistance state is referred to as V_{w}⁻ 232. Choosing the high-resistance state to represent Boolean value “0” and the low-resistance state to represent Boolean value “1,” application of the positive voltage V_{w}⁺ can be considered to be a WRITE-1 operation and application of the negative voltage V_{w}⁻ can be considered to be a WRITE-0 operation. Application of an intermediate-magnitude voltage V_{R} 236 can be used to interrogate the value currently stored in the nanoscale electronic device. When the voltage V_{R} is applied to the device, and when, as a result, a relatively large magnitude current flows through the device, the device is in the low-resistance, or Boolean 1 state, but when relatively little current passes through the device, the device is in the Boolean 0 state. Thus, the nanoscale electronic device illustrated in FIGS. 1A-B and FIG. 2 can serve as a nanoscale memory element, and two-dimensional or three-dimensional arrays of such devices can be employed as two-dimensional and three-dimensional memory arrays.

Although this example, and a subsequent example, feature bistable materials that can have either of two different stable electronic states, depending on the history of voltages applied across the device, devices with three or more stable states can also be used in various applications. For example, a device with three stable slates can store one of three different values “0,”“1,” or “2,” of a base-3 number system, or two of the three stable states of the three-state device can be used for storing a bit value, with the non-assigned state providing further separation from the information-storing states. In many cases, voltage is applied to change the state of a bistable memory element. However, other types of bistable materials may be switched by application of other forces and/or gradients, including temperature for phase-change-material-based devices. Other types of devices may feature types of states other than electrical-resistance states.

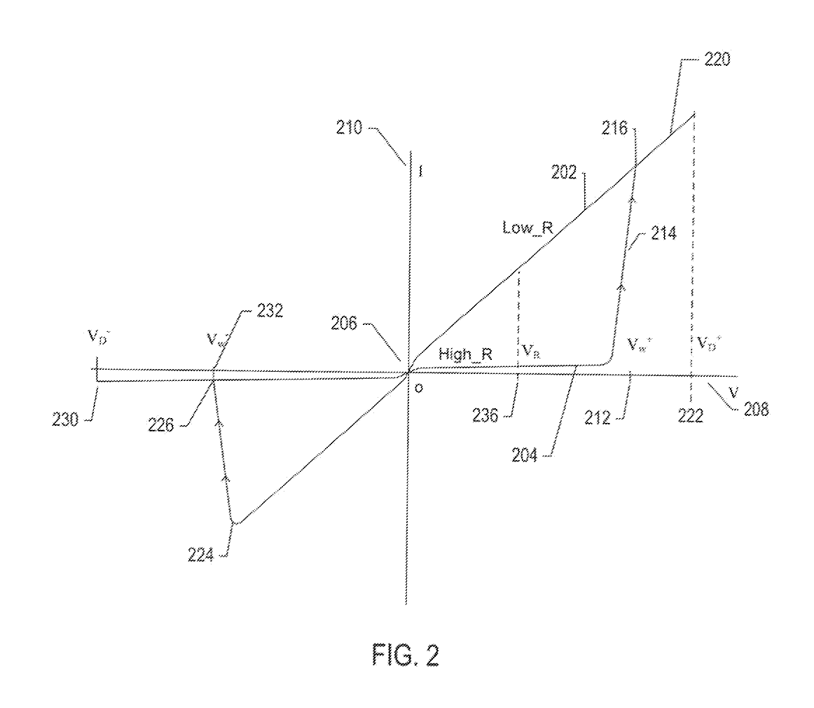

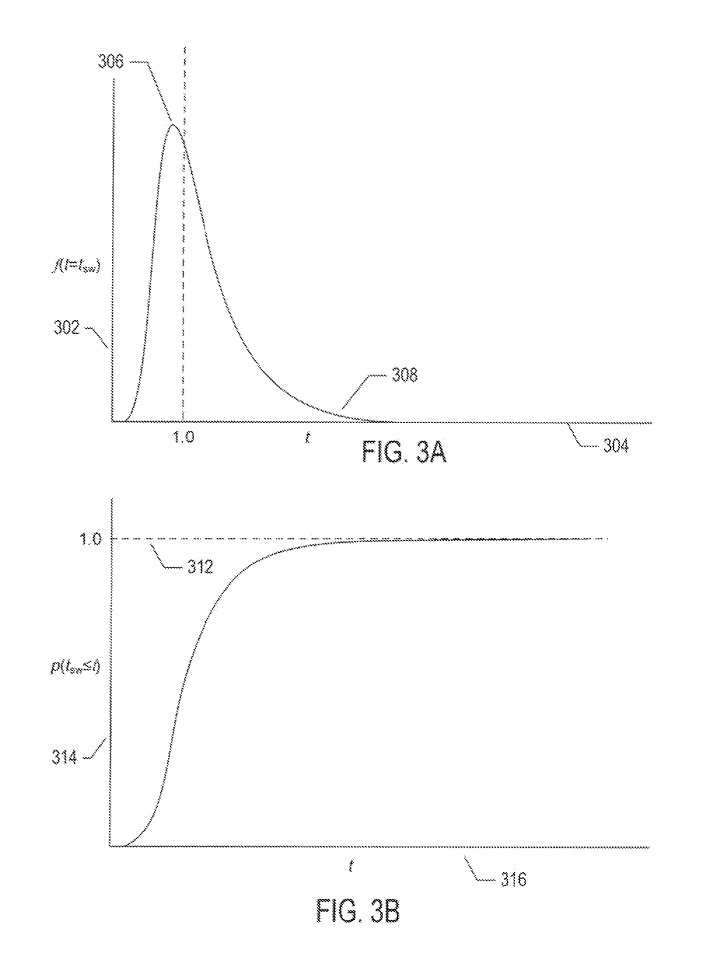

FIG. 2, discussed above, provides a type of idealized description of memristor switching. However, memristive memory elements, and other types of memory elements that exhibit non-linear characteristics under applied voltages or other forces or gradients do not uniformly switch from one bistable state to another with respect to time, but instead, as with many other physical phenomena, exhibit switching times that are probabilistically distributed. Certain memristive memory elements, as one example, exhibit switching times that can be modeled by a log-normal probability distribution. FIG. 3A illustrates a log-normal probability density function (“PDF”), In FIG. 3A, the vertical axis 302 represents the probability density that a particular memristive memory element switches at a time t relative to the starting time for the application of the force or gradient, or, in other words, that time t is equal to the switching time t_{sw} for the device during application of the force or gradient used to switch the memristive memory element from a first state to a second state. In FIG. 3A, the horizontal axis 304 represents time t, with the origin corresponding to a time t=0 when application of the force or gradient is initiated. For the hypothetical log-normal distribution shown in FIG. 3A, the mean switching time t is 1.0, where the unit of time, such as nanoseconds, microseconds, or milliseconds, depend on the particular memristive material and is irrelevant to the current discussion. In a normal probability distribution, or Gaussian distribution, the peak of the probability density function coincides with the mean value of the random variable. However, as can be seen in FIG. 3A, the peak 306 of the probability density function for the log-normal distribution is shifted to the left of the mean value for the independent variable t. The PDF is asymmetrical, unlike a normal or Gaussian PDF, and features an extended right-hand tail 308 corresponding to the fact that there is a significant probability that the actual switching time of a particular memristive memory element to which a voltage or other force or gradient is applied may occur at a time significantly greater than the average or mean switching time.

For many types of electronic devices, including memories, commercial applications demand extremely low error rates. As a result, in order to ensure that a sufficient portion of the memory elements written during a particular application of a write voltage to the memory do indeed switch, the WRITE voltage may need to be applied to the memory for a duration many times that of the average switching time for memory elements or, in other words, for a duration of time such that, for a normalized PDF, the area under the PDF between 0 and the application time approaches 1.0 and the area under the PDF to the right of the duration of application approaches 0. FIG. 3B shows the corresponding cumulative distribution fraction (“CDF”) for the log-normal distribution PDF shown in FIG. 3A. The vertical axis 314 represents the probability of the switching time for a memristive memory element, t_{sw}, being less than or equal time t, and the horizontal axis represents time t. The CDF exhibits a relatively extended, shallow approach 310 to the horizontal dashed line that represents a probability of 1.0 corresponding to the extended right-hand tail of the PDF.

A suitable expression for modeling the PDF for a memristive memory element is provided below:

$${f}_{τ , σ} ( t ) = \frac{1}{\sqrt{2 π} t σ} {e}^{\frac{- {( ln t / τ )}^{2}}{2 {σ}^{2}}} .$$

A suitable expression for modeling the CDF for a memristive memory element is next provided:

$${F}_{τ , σ} ( t ) = \frac{1}{2} erfc ( - \frac{ln ( t / τ )}{\sqrt{2} σ} ) .$$

In the above expression, the function erfc denotes the complementary error function. The PDF and CDF can be viewed as expressions for the distribution of t/τ, where the median value of ln(t/τ) is 0 and ln(t/τ) is Gaussian distributed. The ratio t/τ represents switching times normalized by the median switching time □. The parameter τ is modeled, in certain types of memristive memory elements, by the following expressions:

τ_{ON}=α_{ON}e^{-b}^{_{ON}}^{|ν|}, 3.5 V≦ν≦7 V

τ_{OFF}=α_{OFF}e^{-b}^{_{OFF}}^{|ν|}, −4.75 V≦ν≦−2.75 V.

τ_{ON} is the □ parameter for positive applied voltages, which switch the memristive memory element into the ON or “1” state, and τ_{OFF} is the parameter τ for negative applied voltages that switch the memristive memory element from the “1” or ON state to the “0” or OFF state. The constants α_{ON}, α_{OFF}, b_{ON}, and b_{OFF} are empirically determined positive real constants and ν is the applied switching voltage.

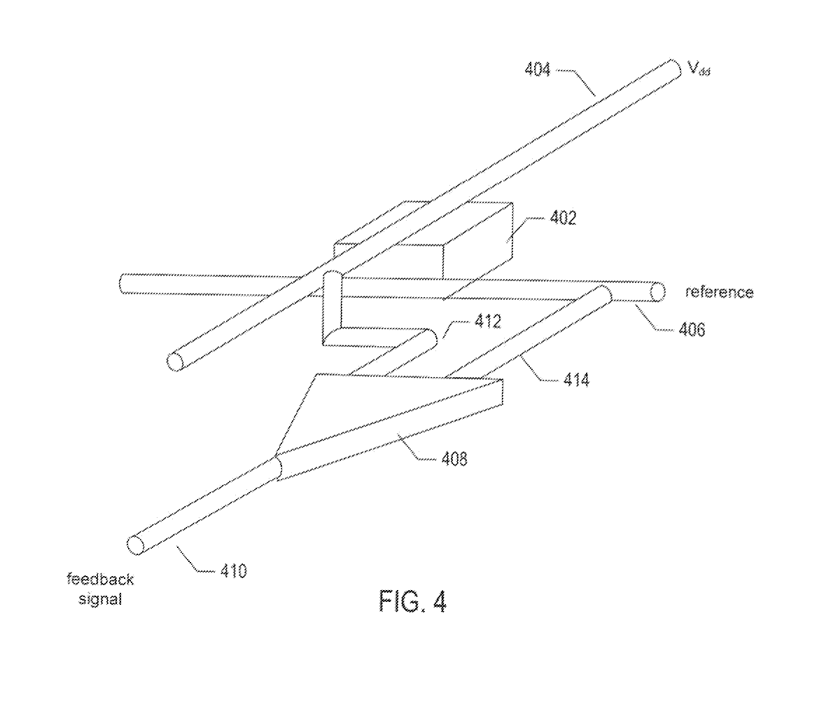

There are two approaches, employed in various examples, for designing and producing cost-effective memory and other data-storage devices, using memory elements characterized by log-normal and/or broadly distributed switching-time PDFs, with desirable data-input bandwidths. These two approaches can each be used separately or in combination. FIG. 4 illustrates a first of the two approaches for ameliorating the effects of log-normal distribution of switching times exhibited by memristive memory elements and other non-linear data-storage materials. FIG. 4 shows a single one-bit memory element 402 sandwiched between two conductors 404 and 406 through which READ and WRITE voltages are applied to the memory element. In addition, the memory element is associated with a circuit element 408, modeled in FIG. 4 as a circuit element which outputs a feedback signal 410 that depends on the voltage difference between two input signals 412 and 414. In this model, for example, a feedback signal may have one voltage value when a positive WRITE voltage is applied through conductors 404 and 406 and the memory element 402 is in a first of two bistable resistance states and may have a different voltage value when a WRITE voltage is applied through conductors 404 and 406 and the memory element 402 is in a second of two bistable resistance stares. The feedback signal 410 thus informs a WRITE controller or other memory circuitry of the current state of the memory element. This allows, as one example, for a WRITE voltage to be applied to the memory element for as long as needed to switch the memory element from a first state to a second state. Thus, as one example, rather than applying a WRITE voltage for a sufficient time to ensure that the memory element has switched to some degree of certainty, where the sufficient time is computed from the PDF characterizing the memory element, the WRITE voltage is applied for a sufficient time to actually switch the memory element. As discussed above with reference to FIG. 3A, the WRITE-voltage application time needed to ensure switching to a high degree of certainty may be many times longer than the average switching time of a particular memristive memory element, and thus the feedback signal generally leads to a significantly shorter average voltage-application time.

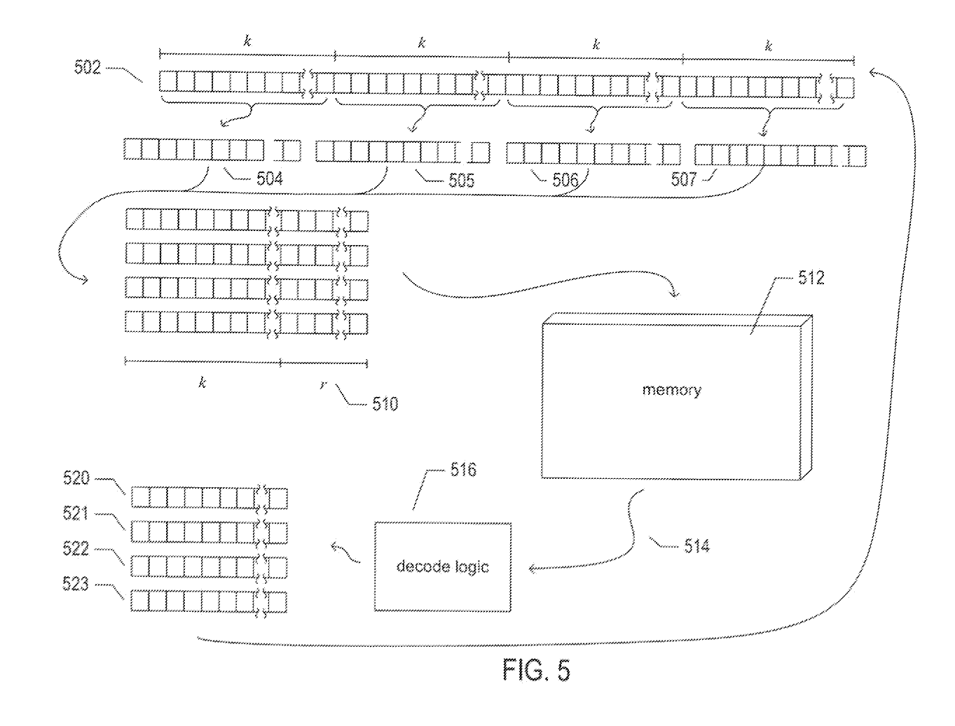

FIG. 5 illustrates a second approach to ameliorating the effects of log-normal distributed switching times for memristive memory elements and other bistable data-storage materials. In FIG. 5, an input quantity of binary data 502, represented as a long array of bit values, with each cell in the array storing a single bit value, is broken up into a number of subarrays of length k 504-507. These k arrays are then encoded, using one of numerous different types of error-control codes (“ECCs”), which results in the addition of r redundant bits to each subarray of length k 510. The encoded subarrays are then stored in a memory 512. When the stored data is retrieved from the memory during a read operation 514, the encoded stored information is decoded by decode logic 516 to produce the k-length sub-arrays 520-523. In general, as discussed in a subsection below, the addition of r redundant bits of information to each k-length subarray allows up to a certain number of incorrectly stored or incorrectly read bits within each k-length sub-array to be corrected by the decode logic. Thus, a certain number of bit errors may be suffered, in the WRITE/READ process, by the memory without leading to erroneous data. Using ECCs, as one example, the length of time during which WRITE voltages are applied may be significantly shortened while achieving the same error rate achieved by using longer application of WRITE voltages but writing and reading uncoded information.

### Error Control Codes

Excellent references for error-control coding are the textbooks “Error Control Coding: Fundamentals and Applications,” Lin and Costello, Prentice-Hall, Incorporated, New Jersey, 1983 and “Introduction to Coding Theory,” Ron M. Roth, Cambridge University Press, 2006. A brief description of the error-detection and error-correction techniques used in error-control coding is next provided. Additional details can be obtained from the above-referenced textbooks or from many other textbooks, papers, and journal articles in this field.

Error-control encoding techniques systematically introduce supplemental bits or symbols into plain-text messages, or encode plain-text messages using a greater number of bits or symbols than absolutely required, in order to provide information in encoded messages to allow for errors arising in storage or transmission to be detected and, its some cases, corrected. One effect of the supplemental or more-than-absolutely-needed bits or symbols is to increase the distance between valid codewords, when codewords are viewed as vectors in a vector space and the distance between codewords is a metric derived from the vector subtraction of the codewords.

In describing error detection and correction, it is useful to describe the data to be transmitted, stored, and retrieved as one or more messages, where a message μ comprises an ordered sequence of symbols, μᵢ, that are elements of a field F. A message μ can be expressed as:

μ=(μ₀,μ₁, . . . μₖ₋₁)

where μᵢ ∈ F.
The field F is a set that is closed under multiplication and addition, and that includes multiplicative and additive inverses. It is common, in computational error detection and correction, to employ finite fields, GF(p^{m}), comprising a subset of integers with size equal to the power m of a prime number p, with the addition and multiplication operators defined as addition and multiplication modulo an irreducible polynomial over GF(p) of degree m. In practice, the binary field GF(2) or a binary extension field GF(2^{m}) is commonly employed, and the following discussion assumes that the field GF(2) is employed. Commonly, the original message is encoded into a message c that also comprises an ordered sequence of elements of the field GF(2), expressed as follows:

c=(c₀,c₁, . . . cₙ₋₁)

where cᵢ ∈ GF(2).

Block encoding techniques encode data in blocks. In this discussion, a block can be viewed as a message μ comprising a fixed number of symbols k that is encoded into a message c comprising an ordered sequence of n symbols. The encoded message c generally contains a greater number of symbols than the original message μ, and therefore n is greater than k. The r extra symbols in the encoded message, where r equals n−k, are used to carry redundant check information to allow for errors that arise during transmission, storage, and retrieval to be detected with an extremely high probability of detection and, in many cases, corrected.

In a linear block code, the 2^{k} codewords form a k-dimensional subspace of the vector space of all n-tuples over the field GF(2), The Hamming weight of a codeword is the number of non-zero elements in the codeword, and the Hamming distance between two codewords is the number of elements in which the two codewords differ. For example, consider the following two codewords a and b, assuming elements from the binary field:

a=(1 0 0 1 1)

b=(1 0 0 0 1)

The codeword a has a Hamming weight of 3, the codeword h has a Hamming weight of 2, and the Hamming distance between codewords a and b is 1, since codewords a and b differ in the fourth element. Linear block codes are often designated by a three-element tuple [n, k, d], where n is the codeword length, k is the message length, or, equivalently, the base-2 logarithm of the number of codewords, and d is the minimum Hamming distance between different codewords, equal to the minimal-Hamming-weight, non-zero codeword in the code.

The encoding of data for transmission, storage, and retrieval, and subsequent decoding of the encoded data, can be notationally described as follows, when no errors arise during the transmission, storage, and retrieval of the data:

μ→c(s)→c(r)→μ

where c(s) is the encoded message prior to transmission, and c(r) is the initially retrieved or received, message. Thus, an initial message μ is encoded to produce encoded message c(s) which is then transmitted, stored, or transmitted and stored, and is then subsequently retrieved or received as initially received message c(r). When not corrupted, the initially received message c(r) is then decoded to produce the original message μ. As indicated above, when no errors arise, the originally encoded message c(s) is equal to the initially received message c(r). and the initially received message c(r) is straightforwardly decoded, without error correction, to the original message μ.

When errors arise during the transmission, storage, or retrieval of an encoded message, message encoding and decoding can be expressed as follows:

μ(s)→c(s)→c(r)→μ(r).

Thus, as stated above, the final message μ(r) may or may not be equal to the Initial message μ(s), depending on the fidelity of the error detection and error correction techniques employed to encode the original message μ(s) and decode or reconstruct the initially received message c(r) to produce the final received message μ(r). Error detection is the process of determining that:

c(r)≠c(s)

while error correction is a process that reconstructs the initial, encoded message from a corrupted initially received message:

c(r)→c(s).

The encoding process is a process by which messages, symbolized as μ, are transformed into encoded messages c. Alternatively, a message μ can be considered to be a word comprising an ordered set of symbols from the alphabet consisting of elements of F, and the encoded messages c can be considered to be a codeword also comprising an ordered set of symbols from the alphabet of elements of F. A word μ can be any ordered combination of k symbols selected from the elements of F, while a codeword c is defined as an ordered sequence of n symbols selected from elements of F via the encoding process:

{c:μ→c}.

Linear block encoding techniques encode words of length k by considering the word μ to be a vector in a k-dimensional vector space, and multiplying the vector μ by a generator matrix, as follows:

c=μ·G.

Notationally expanding the symbols in the above equation produces either of the following alternative expressions:

$$( {c}_{0} , {c}_{1} , … , {c}_{n - 1} ) = ( {μ}_{0} , {μ}_{1} , … , {μ}_{k - 1} ) ( \begin{matrix}{g}_{00} & {g}_{01} & {g}_{02} & … & {g}_{0 , n - 1} \\ & ⋮ & & ⋱ & ⋮ \\ {g}_{k - 1 , 0} & {g}_{k - 1 , 1} & {g}_{k - 1 , 2} & … & {g}_{k - 1 , n - 1}\end{matrix} )$$

$$( {c}_{0} , {c}_{1} , … , {c}_{n - 1} ) = ( {μ}_{0} , {μ}_{1} , … , {μ}_{k - 1} ) ( \begin{matrix}{g}_{0} \\ {g}_{1} \\ \begin{matrix}⋮ \\ ⋮ \\ ⋮\end{matrix} \\ {g}_{k - 1}\end{matrix} )$$

where gᵢ=(g_{i,0},g_{i,1},g_{i,2} . . . g_{i,n-1}).

The generator matrix G for a linear block code can have the form:

$${G}_{k , n} = ( \begin{matrix}{p}_{0 , 0} & {p}_{0 , 1} & … & {p}_{0 , r - 1} & 1 & 0 & 0 & … & 0 \\ {p}_{1 , 0} & {p}_{1 , 1} & … & {p}_{1 , r - 1} & 0 & 1 & 0 & … & 0 \\ … & … & … & & 0 & 0 & 1 & … & 0 \\ … & … & … & & … & … & … & … & … \\ … & … & … & & … & … & … & … & … \\ {p}_{k - 1 , 0} & {p}_{k - 1 , 1} & … & {p}_{k - 1 , r - 1} & 0 & 0 & 0 & … & 1\end{matrix} )$$

or, alternatively:

G_{k,n}=[P_{k,r}|I_{k,k}].

Thus, the generator matrix G can be placed into a form of a matrix P augmented with a k by k identity matrix I_{k,k}. Alternatively, the generator matrix G can have the form:

G_{k,n}=[I_{k,k}|P_{k,r}].

A code generated by a generator matrix in this form is referred, to as a “systematic code.” When a generator matrix having the first form, above, is applied to a word μ, the resulting codeword c has the form:

c=(c₀,c₁, . . . ,cᵣ₋₁,μ₀,μ₁, . . . ,μₖ₋₁)

where cᵢ=μ₀P_{0,i}+μ₁p_{1,i}, . . . ,μₖ₋₁p_{k-1,i}). Using a generator matrix of the second form, codewords are generated with trailing parity-check bits. Thus, in a systematic linear block code, the codewords comprise r parity-check symbols cᵢ followed by the k symbols comprising the original word μ or the k symbols comprising the original word μ followed by r parity-check symbols. When no errors arise, the original word, or message μ, occurs in clear-text form within, and is easily extracted from, the corresponding codeword. The parity-check symbols turn out to be linear combinations of the symbols of the original message, or word μ.

One form of a second, useful matrix is the parity-check matrix H_{r,n,} defined as:

H_{r,n}=[I_{r,r}|−P^{T}]

or, equivalently,

$${H}_{r , n} = ( \begin{matrix}1 & 0 & 0 & … & 0 & - {p}_{0 , 0} & - {p}_{1 , 0} & - {p}_{2 , 0} & … & - {p}_{k - 1 , 0} \\ 0 & 1 & 0 & … & 0 & - {p}_{0 , 1} & - {p}_{1 , 1} & - {p}_{2 , 1} & … & - {p}_{k - 1 , 1} \\ 0 & 0 & 1 & … & 0 & - {p}_{0 , 2} & - {p}_{1 , 2} & - {p}_{2 , 2} & … & - {p}_{k - 1 , 2} \\ … & … & … & … & … & … & … & … & … & … \\ 0 & 0 & 0 & … & 1 & - {p}_{0 , r - 1} & - {p}_{1 , r - 1} & - {p}_{2 , r - 1} & … & - {p}_{k - 1 , r - 1}\end{matrix} ) .$$

The parity-check matrix can be used for systematic error detection and error correction. Error detection and correction involves computing a syndrome S from an initially received or retrieved message c(r) as follows:

S=(s₀, s₁, . . . ,sᵣ₋₁)=c(r)·H^{T}

where H^{T} is the transpose of the parity-check matrix H_{r,n} expressed as:

$${H}^{T} = ( \begin{matrix}1 & 0 & 0 & … & 0 \\ 0 & 1 & 0 & … & 0 \\ 0 & 0 & 1 & … & 0 \\ … & … & … & … & 1 \\ - {p}_{0 , 0} & - {p}_{0 , 1} & - {p}_{0 , 2} & … & - {p}_{0 , r - 1} \\ - {p}_{1 , 0} & - {p}_{1 , 1} & - {p}_{1 , 2} & … & - {p}_{1 , r - 1} \\ - {p}_{2 , 0} & - {p}_{2 , 1} & - {p}_{2 , 2} & … & - {p}_{2 , r - 1} \\ … & … & … & … & … \\ - {p}_{k - 1 , 0} & - {p}_{k - 1 , 1} & - {p}_{k - 1 , 2} & … & {p}_{k - 1 , r - 1}\end{matrix} ) .$$

Note that, when a binary field is employed, x=−x, so the minus signs shown above in H^{T} are generally not shown.

The syndrome S is used for error detection and error correction. When the syndrome S is the all-0 vector, no errors are detected in the codeword. When the syndrome includes bits with value “1” errors are indicated. There are techniques for computing an estimated error vector ê from the syndrome and codeword which, when added by modulo-2 addition to the codeword, generates a best estimate of the original message μ. Details for generating the error vector ê are provided in the above mentioned texts. Note that up to some maximum number of errors can be detected, and fewer than the maximum number of errors that can be detected can be corrected.

### Hypothetical WRITE Methods

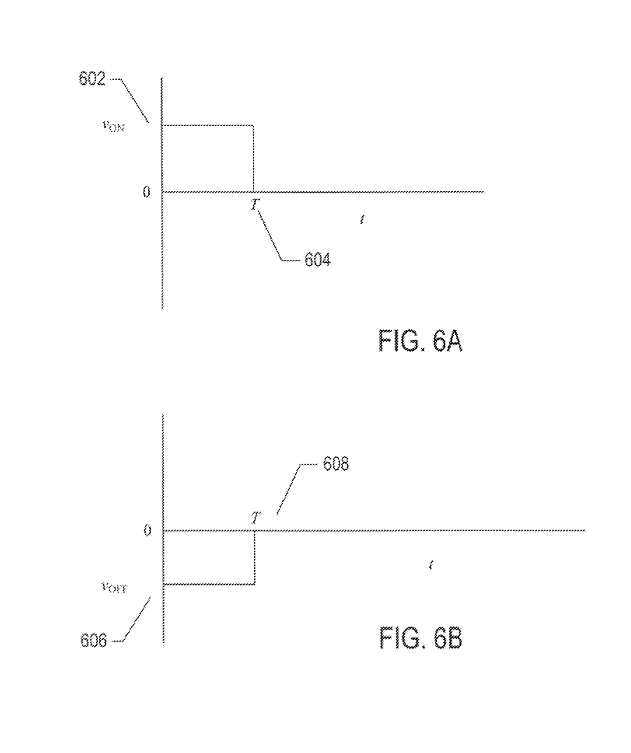

FIGS. 6A-B illustrate application of a switching pulse to a memristive memory element, or other non-linear data-storage material. For much of the following discussion, application of a switching pulse or multiple switching pulses is considered. A switching pulse may be either application of a positive voltage, ν_{ON} 602 for a time duration t 604 or application of a negative voltage ν_{OFF} 606 for a time duration t 608. In either case, the proper τ parameter is selected from τ_{ON} and τ_{OFF} for computing an appropriate log-normal switching-time PDF and corresponding CDF from which the duration of a pulse T can be determined, whom T is in units of multiples of the average switching time, that provides a probability that the memory elements switches above a specified minimum switching probability corresponding to a maximum desirable bit-error rate (“BER”).

The probability of a switching failure, P_{b}(T), for a given memory element, or the bit-error rate for a multi-memory-element device, is computed from the above-discussed log-normal CDF as follows:

P_{b}(T)=1−F_{τ,σ}(T), T≧0.

where F_{τ,σ}(T) is the above-discussed CDF. In the following discussion, for simplicity, the asymmetry between on-switching and off-switching is ignored, as are cases in which a successfully applied WRITE operation does not change the state of a memory element and, therefore, failure of the WRITE operation does not change the state of a memory element. Ignoring these cases does not alter comparisons between various methods, discussed below. In the following discussion, switching failure of memristive memory elements and other non-linear data-storage materials is modeled as a binary symmetric noisy channel.

In the following discussion, when ECCs are employed, it is assumed that the code C is an [n,k,d] code and that, therefore, up to (d−1)/2 bit errors that occur in writing and/or reading each codeword can be corrected. Of course, the ability to recover from bit errors comes at the cost of the redundant bits r that are added to each group of binary information bits of length k, resulting in an information rate R defined as:

information rate=R=k/n

R<1 for coded information

R=1 for uncoded information.

As discussed above, when uncoded information is stored into and retrieved from a memory, the fraction of erroneous bits in the retrieved information from memory, assuming that no errors occur during reading of the stored information, is P_{b}, the probability of switching failure or BER. When coded information is stored into a memory, subsequently retrieved, and processed by an error-correcting decoder, the BER \hat{P}_{b} is

$${\hat{P}}_{b} = \frac{1}{n} {\sum }_{i = s + 1}^{n} i ( \begin{matrix}n \\ i\end{matrix} ) {{p}_{b}^{i} ( 1 - {p}_{b} )}^{n - i}$$

where s=└(d−1)/2┘=maximum number of bits correctable by code C, an [n,k,d]code
   In this expression, the probabilities of all error patterns including a number of errors that exceeds the maximum number of errors that can be corrected by the ECC are summed together and divided by n, the length of the codewords.

Next, a number of different data-writing methods that employ one or both of feedback signals and ECC, discussed above with reference to FIGS. 4 and 5, are considered. First, various notational conventions used in these discussions are outlined.

For single-pulse methods, the total time of application of a WRITE voltage, Tₜ, or other force or gradient used to switch a memory element, is equal to T, the duration of the single pulse. For multiple-pulse methods, Tₜ is equal to the sum of the multiple pulses:

Tₜ=T₀+ . . . +Tᵢ.

The average voltage-application time, T_{avg}, is the expected total application time:

T_{avg}=E(Tᵢ).

For single-pulse methods, T_{avg}=T. The average voltage-application time per bit for methods that employ ECC, T′_{avg}, is:

T′_{avg}=T_{avg}/R=pulse time/bit,

accounting for the additional time used to write the added redundant bits. Finally, the gain G or expected savings in energy consumption or memory bandwidth per information bit for a particular data-writing method w, is;

$$G = 10 {log}_{10} \frac{{T}_{avg , r}}{{T}_{avg , w}^{*}}$$

where G is expressed in dB;
T_{avg,r} is the expected pulse length for the uncoded, one-pulse scheme discussed below;
T_{avg,w} is the average pulse time, per bit, for the particular data-writing method.

Thus, the following comparisons, uncoded BERs P_{b}, coded BERs \hat{P}_{b}, total time of application of voltages or other forces and/or gradients employed to write data Tₜ, the average application time for multi-pulse methods T_{avg}, the average pulse time per bit T′_{avg}, and the gain G are evaluated to facilitate comparison of the different data-writing methods. While T′_{avg} is the appropriate figure of merit to use when comparing energy consumption and memory bandwidth between different WRITE methods, T_{avg} and Tₘₐₓ are reflective of device wear and worst-ease latency considerations.

As discussed above, one approach for ameliorating the potentially long WRITE-voltage application times needed to ensure high reliability for data storage in devices with memory elements that exhibit log-normal distribution of switching times is to use a feedback signal that allows a memory controller to determine, at selected points in time, whether a particular memory element has switched. It should be noted that this feedback-signal-based method for decreasing the average duration of application of WRITE voltages incurs significant costs in additional circuitry and circuit elements. Similarly, as discussed above, the ability to correct errors provided by the use of ECCs involves storing of additional, redundant bits that decreases the information rate for a memory device.

In the following discussion, various simplifications are made. For example, in the above-provided expression for \hat{P}_{b}, it is assumed that a decoder always fails when more than s bits of a codeword are corrupted or, in other words, the decoder is always able to detect uncorrectable error patterns. When the decoder detects an uncorrectable error pattern, the decoder discontinues attempting to decode the codeword, but does not introduce additional errors. In practice, this is not always the case. There is a small probability that the decoder will generate an incorrectly decoded codeword for an uncorrectable error pattern. The assumption is that this probability is ignored, which is reasonable in practice, since making this assumption does not significantly affect the result of the overall BER computation.

There are many different parameters that might be optimized for devices that feature memory elements with log-normally distributed switching times. For example, in addition to changing the length T and number of pulses during which a WRITE voltage, or other force or gradient, is applied, the voltage itself may be varied, with higher voltages generally decreasing the average pulse time needed to achieve a particular BER, but also increasing energy expended by a memory or other data-storage device to store information. It turns out, however, that, in many cases, there is no optimal WRITE voltage within the range of WRITE voltages that may be applied, but, instead, using larger-magnitude WRITE voltages generally results in expending less energy. In other words, the larger the WRITE voltage applied to a memory element, the shorter the WRITE voltage needs to be applied and the less total energy is expended to switch a memory element. Of course, at some point, increasing the WRITE voltage leads to failure of the device, and the longevity of the device may also be negatively impacted by use of high WRITE voltages. As another example, the variance □ of the natural logs of switching times, modeled, as discussed above, by the above-provided PDF and CDF expressions, is dependent on the applied WRITE voltage. However, the dependence is weak, and thus does not constitute a good candidate parameter for optimization.

In the following discussion, as mentioned above, application times are reported in units of τ, or, in other words, the random variable is t/τ. Thus, in the following discussion, the results are provided in a time-scale-independent fashion. In the following computation of various parameters for various information-writing methods, a binary Bose, Ray-Chaudhuri, Hocquenghem (“BCH”) ECC code C is used. This code is a [4304, 4096, 33] ECC, with R≈0.952, which can correct up to 16 random errors per 4096-bit code blocks. This particular code is used, in the following discussion, for good performance in correcting switching-failure errors, although in actual memory systems, additional considerations for selecting codes would also include the types of failure modes of the code and the ability of the code to adequately handle various types of correlated multi-bit errors. In the following analysis, two different target BER levels are considered: (1) P_{b}=10⁻¹², representing the lower end of BER levels for current storage devices and corresponding to storing of a two-hour high-definition movie without expected errors; and (2) P_{b}=10⁻²³, representative of future desired BER levels.

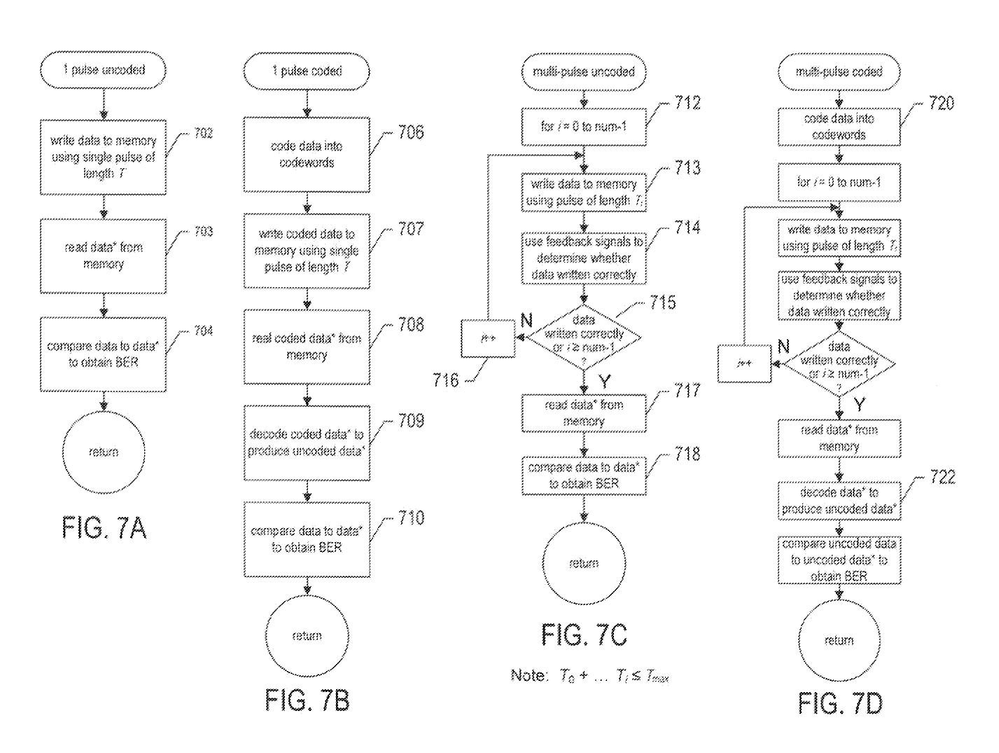

FIGS. 7A-F illustrate six different data-writing methods for writing data to a memory device that includes memory elements characterized by log-normally distributed switching times. These methods constitute hypothetical experiments in which various parameters for six different data-writing methods are determined by first writing the data to a memory and then reading the data back from memory. As discussed subsequently, parameters can be estimated for these hypothetical experiments based on the log-normal-distribution PDF and CDF along with other assumptions and considerations.

In a first method, shown in FIG. 7A, referred to as a “one-pulse-uncoded WRITE method,” data is written to the memory using a single pulse of length T, in step 702, read back from the memory in step 703, and the data read back from the memory is compared to the data initially written to the memory in order to determine the BER for the one-pulse-uncoded WRITE method, in step 704. Of course, the experiment would be repeated many times, or many memory elements would be tested, or both in order to achieve statistically meaningful results. The one-pulse-uncoded method represents a reference point to which additional methods, which employ one or more of ECCs and feedback signals, are compared, below. In a one-pulse-coded method, shown in FIG. 7B, data is first encoded into codewords, in step 706 and then written to memory using a single WRITE pulse of length T in step 707. In step 708, the data is read back from memory and decoded, in step 709, following which the decoded data is compared to the data originally stored into memory to obtain the BER for the one-pulse-coded method in step 710. In the multi-pulse, uncoded method, shown in FIG. 7C, the data is written in multiple pulses. In the for-loop of steps 712-716, a sequence of pulses is used to attempt to write data to the memory. In each iteration of the for-loop, data is attempted to be written using a next pulse of length Tᵢ, where i is an iteration variable indicating the number or index of the current iteration. Then, in step 714, the feedback signal provided from feedback-enabled memory elements is considered to determine whether or not the data has been correctly written to memory. Alternatively, the memory element may be read to verify that switching has occurred. When the data has not been correctly written to memory and when the current iteration index i is less than the iteration-termination value num, as determined in step 715, then a next iteration of the for-loop is carried out. Otherwise, the data is read hack from memory, in step 717, and compared to the data written to memory in order to determine the BER from the multi-phase, uncoded method. The sum of the pulse times T₀+ . . . +Tᵢ is, as discussed above, equal to the total pulse time Tₜ which is, in turn, less than or equal to a specified maximum voltage application duration Tₘₐₓ. For purposes of modeling this and related methods, it is assumed that the probability of switching is related to the total accumulated time of voltage application over the one or more pulses applied to memory elements in a WRITE operation. In other words, application of a WRITE voltage in three, one-second pulses is equivalent to applying the WRITE voltage for a single three-second pulse. The multi-pulse coded method, shown in FIG. 7D, is similar to the multi-pulse uncoded method, discussed above with reference to FIG. 7C, with the exception that the data is first encoded, using an ECC, in step 720, and subsequently decoded, in step 722.

FIG. 7E shows a continuous uncoded method. The continuous uncoded method is equivalent to the limit of the multi-pulse, uncoded method where the pulse times Tᵢ are shortened to infinitesimal periods that together add up to a maximum voltage-application time Tₘₐₓ. In step 724, a WRITE voltage is applied to the memory device to begin writing data to memory elements within the device. Then, in the while-loop of steps 725-726, the feedback signal from the memory elements is continuously monitored to determine when the memory elements intended to be switched by application of a WRITE voltage have, in fact, switched to their desired states. When that happens, the while-loop is terminated, the data is read back from memory in step 727, and the data is compared to the originally written data to determine the BER for the continuous uncoded method in step 728. The continuous coded method, shown in FIG. 7F, is similar to the continuous uncoded method, with the exception that the data is first encoded using an ECC, in step 730, and subsequently decoded, in step 732, after being read from memory.

All of the methods illustrated in FIGS. 7A-F represent hypothetical data-storage methods that employ, in the case of the one-pulse-uncoded method, neither feedback nor ECC, or that employ one or both of feedback and ECC. Feedback is employed in the multi-pulse encoded and multi-pulse coded methods as well as in the continuous uncoded and continuous coded methods. ECCs are employed in the one-pulse-coded, multi-pulse-coded, and continuous-coded methods. For the one-pulse methods, T_{avg}=Tₘₐₓ=T. For the one-pulse-coded method, T′_{avg}=T_{avg}/R. For the one-pulse uncoded method, T′_{avg}=T_{avg}.

### Analysis of the Various WRITE Methods

In this section, the approaches to analyzing the various WRITE methods, discussed with reference to FIGS. 7A-F, are discussed. The analysis provides estimates of the various parameters, including T_{avg}, T′_{avg}, and G, discussed above. The results of the various analyses are discussed in a following subsection.

In the one-pulse methods, the choice of T determines the input BER, P_{b}(T), of the stored data, which, in the coded method, is assumed to have been encoded with C. The output BER of the coded method is then estimated by using the parameters n=4304, s=16, of the above-described BCH code.

A multi-pulse WRITE method using two pulses is the simplest data-writing method with feedback. An initial pulse of duration T₁ is applied, and the state of the device is sensed. When the device is found to have switched to the desired target state, the WRITE operation is deemed complete. When the device has not switched, an additional pulse of duration Tₘₐₓ−T₁ is applied, where Tₘₐₓ>T₁. Notice that, although interrupting the operation at time T₁ reduces the average total pulse time, the switching failure probability is still determined by Tₘₐₓ, as a result of which P_{b}=1−F_{τ,σ}(Tₘₐₓ). The expected total pulse duration is

T_{avg}(Tₘₐₓ,T₁)=F_{τ,σ}(T₁)T₁+(1−F_{τ,σ}(T₁))Tₘₐₓ.

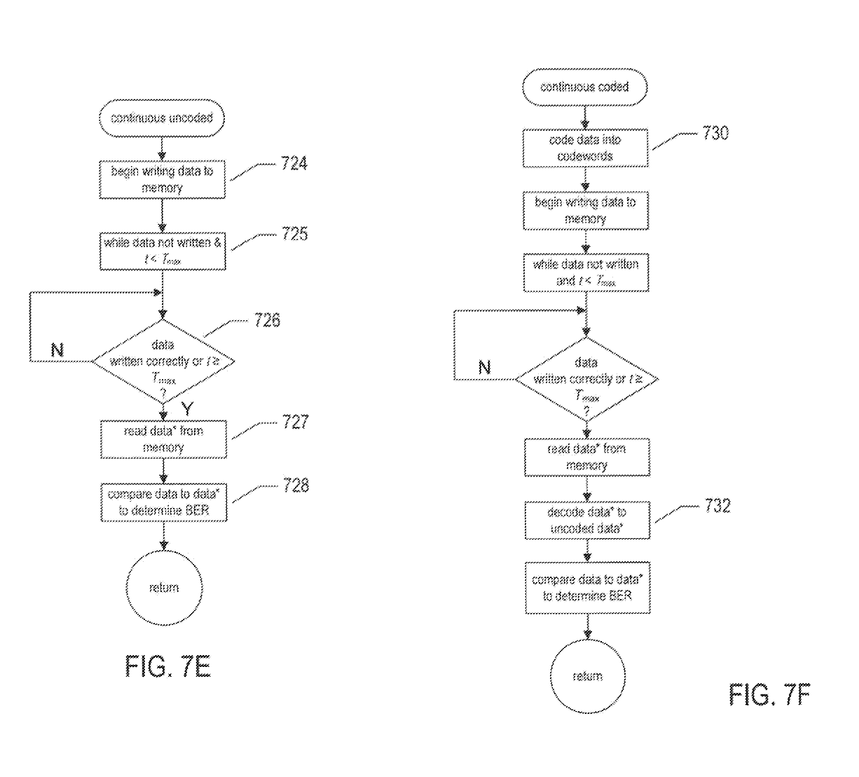

Given a target value of P_{b}, the value of T₁ that minimizes T_{avg} can be computed. Indeed, it is readily verified that T_{avg}(Tₘₐₓ,0)=T_{avg}(Tₘₐₓ,Tₘₐₓ)=Tₘₐₓ, and that, as a function of T₁, T_{avg} has a sharp minimum in the interval (0,Tₘₐₓ). FIG. 8 illustrates the dependence of the total expected time of application of a WRITE voltage, T_{avg}, on the length of the first pulse, T₁, in a two-pulse WRITE method. To find the value of T₁ minimizing T_{avg}, the right-hand side of

the above expression is differentiated, after substituting the full expression for F_{τ,σ}, provided above, and solved numerically for the zero of the derivative, which is denoted by T₁^{opt}(Tₘₐₓ). The optimal expected total pulse length is then given by T_{avg}(Tₘₐₓ,T₁^{opt}(Tₘₐₓ)).

For a binary symmetric noisy channel, the 2-pulse method is identical to the 1-pulse method, except that, in expectation, far shorter pulses and, correspondingly, far less energy, are used to obtain the same BER. The worst-case pulse durations are the same as in the 1-pulse case. Also as in the 1-pulse case, using ECC results in further decreases In expected pulse lengths and energy consumption, but, additionally, in large reductions in worst-case to average pulse-length ratios.

Three-pulse WRITE methods are analysed in similar fashion to the two-pulse WRITE methods, except that sensing of the state of the memory element is allowed at discrete times T₁ and T₂, 0≦T₁≦T₂≦Tₘₐₓ. The expected total pulse length is given by the formula:

T_{avg}(Tₘₐₓ,T₁,T₂)=F_{τ,σ}(T₁)T₁+(F_{τ,σ}(T₂)−F_{τ,σ}(T₁))T₂+(1−F_{τ,σ}(T₂))Tₘₐₓ.

For a given value of Tₘₐₓ corresponding to a target value of P_{b}, T_{avg} exhibits a deep global minimum in T₁ and T₂, which is easily found by taking partial derivatives with respect to T₁ and T₂ and solving the resulting system of equations by means of numerical methods.

In continuous-feedback WRITE methods, a pulse of maximal duration Tₘₐₓ is used while the state of the device is continuously monitored, with the applied voltage turned off immediately after switching occurs. The expected pulse length for for a continuous-feedback WRITE method is given by

$$\begin{matrix}{T}_{avg} ( {T}_{max} ) = {\int }_{t = 0}^{{T}_{max}} {tf}_{τ , σ} ( t ) d t + ( 1 - {F}_{τ , σ} ( {T}_{max} ) ) {T}_{max} \\ = \frac{1}{2} {τe}^{\frac{1}{2} {σ}^{2}} erfc ( \frac{- ln ( {T}_{max} / τ ) + {σ}^{2}}{\sqrt{2} σ} ) + \\ ( 1 - \frac{1}{2} erfc ( - \frac{ln ( {T}_{max} / τ )}{\sqrt{2} σ} ) ) {T}_{max} .\end{matrix}$$

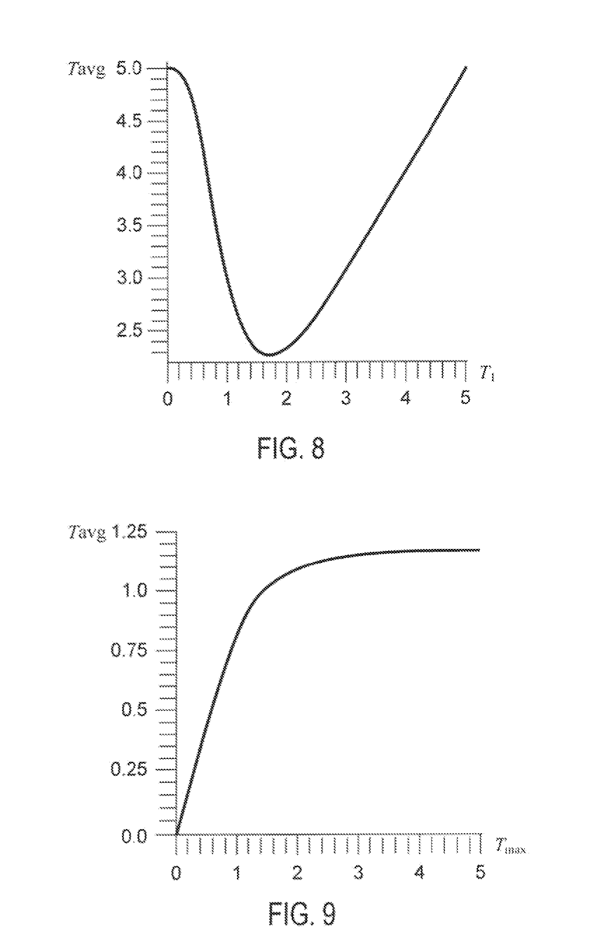

When Tₘₐₓ tends to infinity, the above expression tends, as expected, to T̅(τ,σ)=τe^{1/2σ}^{²}, the mean of the log-normal density ƒ_{τ,σ}. In fact, this limit is approached rather rapidly when Tₘₐₓ/τ>1. FIG. 9 illustrates the dependence of the expected cumulative time of application of a WRITE voltage, T_{avg}, on the maximum application time Tₘₐₓ for a continuous WRITE method.

Feedback offers significant gains in the expected duration of WRITE operations. These gains translate directly to reduced expected energy consumption and reduced wear on the devices. The use of ECC further enhances these gains, sometimes by significant margins. Additionally, the very significant reductions in Tₘₐₓ due to coding lead to corresponding gains in system throughput, even when WRITE requests are restricted to occur at least Tₘₐₓ units of time apart. To let throughput benefit also from the reduction in T_{avg}, and increase operation rate beyond the Tₘₐₓ limitation, a queueing or buffering mechanism for write operations may be implemented, as some operations will take time Tₘₐₓ, and WRITE requests arriving at a higher rate will have to be queued and wait while these operations complete. The buffering needs and reliability of such a system can be analyzed using the tools of queueing theory.

Consider a 2-pulse method, with parameters T₁, Tₘₐₓ, and T_{avg}. Assume, for simplicity, that WRITE requests arrive at a fixed rate, with an inter-arrival period of A units of time. If A≧Tₘₐₓ, no queueing is needed, so it is assumed that A<Tₘₐₓ. Clearly, A>T₁ for the queue to have any chance of remaining bounded (in fact, from well-known results in queueing theory, and as will also transpire from the analysis below, A>T_{avg}. A further simplifying assumption is that the ratio d=(Tₘₐₓ−A)/(A−T₁) is an integer. Because the ratios Tₘₐₓ/T_{avg} are rather large, this is not a very restrictive assumption, given a target BER a with a certain value of Tₘₐₓ. In most cases, Tₘₐₓ can be slightly increased to make d an integer. With these assumptions, the analysis of the waiting time in the queue reduces to studying the simple integer-valued random walk.

Let wᵢ denote an integer random variable representing the waiting time in the queue of the i^{th} WRITE request (the actual waiting time being (A−T₁)wᵢ), and let p=P(tᵢ=T₁), where tᵢ is the actual total pulse length of the i^{th} WRITE, the service time for the i^{th} WRITE request. Let (a-b)⁺ denote a-b when a>b, or 0 otherwise. Then, taking w₀=0 as the initial condition

wᵢ₊₁=(wᵢ−D₁)⁺, i≧1,

where Dᵢ is a random variable assuming values in {1,−d}, with P(Dᵢ=1)=p, and P(Dᵢ=−d)=1−p. By previous assumptions, these probabilities are independent of i. The random walk wᵢ is a Markov chain which, for sufficiently large p, is persistent returning infinitely often to the state wᵢ=0. Under this assumption, the chain has a stationary distribution

$${P}_{w} = {lim}_{i -> ∞} P ( {w}_{i} = w ) .$$

Clearly, a state wᵢ₊₁=w in the range 1≦w≦d−1 can be reached from wᵢ=w+1, through Dᵢ=1. Therefore

P_{w}=pP_{w+1}=p²P_{w+2}= . . . =p^{d-w}P_{d}=p^{d-w}u, 1≦≦w≦d,

where u=P_{d}. State w=0, on the other hand, can be reached from either w=0 or w=1, again with Dᵢ=1. Thus, P₀=pP₀+pP₁=pP₀+p^{d}u. Solving for P₀

$${P}_{0} = \frac{{p}^{d}}{1 - p} u .$$

Finally, for w≦d, state w can be reached from w+1 with Dᵢ=1, or from w−d with Dᵢ=−d, yielding the recursion

P_{w}=(1−p)P_{w-d}+pP_{w+1}, w≧d.

An explicit expression for the generating function can be obtained from the above expressions as

$$G ( z ) = {\sum }_{w = 0}^{∞} {P}_{w} {z}^{w} ,$$

from which, in turn, the expectation of the waiting time can be derived

$$E [ w ] = \frac{( 1 - p ) ( 1 + d ) d}{2 ( 1 - ( 1 - p ) ( 1 + d ) )} .$$

Letting W=(A−T₁)w, and translating back to time units

$$E [ W ] = \frac{( {T}_{avg} - {T}_{1} ) ( {T}_{max} - A )}{2 ( A - {T}_{avg} )} , {T}_{avg} < A \leq {T}_{max} .$$

As expected, E[W] approaches zero when A approaches Tₘₐₓ (no queue is used when A≧Tₘₐₓ), and E[W] approaches infinity when A approaches T_{avg}. By Little's theorem [3], the expectation of the queue size, Q, is given by

E[Q]=E[W]/A.

It is clear from above-provided expressions that the variable u multiplies all the probabilities P_{w}. Consider

G(z)=uG₀(z)z′+uz^{d}G₁(z),

where

$${G}_{0} ( z ) = {u}^{- 1} {\sum }_{w = 0}^{d - 1} {P}_{w} {z}^{w}$$

$$and$$

$${G}_{1} ( z ) = {u}^{- 1} {\sum }_{w = d}^{∞} {P}_{w} {z}^{w - d} .$$

An explicit expression for G₀(z) follows directly, yielding

$${G}_{0} ( z ) = \frac{{p}^{d}}{1 - p} + pz \frac{{p}^{d - 1} - {z}^{d - 1}}{p - z} .$$

As for G₁(z), applying the expression for G₁(z) and the above-provided recursion, and recalling that u=P_{d}, the following expression is obtained

$$\begin{matrix}{uG}_{1} ( z ) = {\sum }_{w = d}^{∞} {P}_{w} {z}^{w - d} \\ = ( 1 - p ) {\sum }_{w = d}^{∞} {P}_{w - d} {z}^{w - d} + p {\sum }_{w = d}^{∞} {P}_{w + 1} {z}^{w - d} \\ = ( 1 - p ) G ( z ) + {upz}^{- 1} ( {G}_{1} ( z ) - 1 ) \\ = u ( 1 - p ) ( {G}_{0} ( z ) + {z}^{d} {G}_{1} ( z ) ) + {upz}^{- 1} ( {G}_{1} ( z ) - 1 ) .\end{matrix}$$

Rearranging terms, and after some algebraic manipulations, the following expressions are obtained

$$\begin{matrix}{G}_{1} ( z ) = \frac{p - ( 1 - p ) {zG}_{0} ( z )}{( 1 - z ) - ( 1 - p ) ( 1 - {z}^{d + 1} )} \\ = \frac{p - \frac{pz}{p - z} ( {g}_{d} ( z ) ( 1 - p ) - ( 1 - {p}^{d} ) )}{1 - ( 1 - p ) {g}_{d + 1} ( z )} ,\end{matrix}$$

where gₕ(z)=(1−z^{h})/(1−z) for integers h≧1 eliminates a common factor (1−z) from the numerator and denominator of the expression for G₁(z). The above expressions determine G(z) up to a factor of u. Setting G(1)=1, the following expression is obtained

u=(1−p)((d+1)p−d)p^{-(d+1)},

which completes the determination of G(z). The expectation of w is given by

$$E [ w ] = \frac{d G ( z )}{d z} {\vert}_{z = 1} ,$$

which yields the first-provided expression for E[w]. The second expression for E[W], provided above, then follows by substituting d=(Tₘₐₓ−A)/(A−T₁) into the first-provided expression, multiplying by the time scale A-T₁, and recalling that T_{avg}=pT₁+(1−p)Tₘₐₓ. Notice that, for u to be positive, p>d/(d+1), leading to A>T_{avg}.

Again consider discrete pulsing WRITE methods with intervening reads to verify switching, but rather than imposing an explicit limit on the number of pulses, consider instead imposing a penalty on the verification/read operation and determine the optimal pulsing method subject to this penalty.

Let T₁<T₂< . . . <Tₙ₋₁<Tₘₐₓ denote a sequence of pulse ending times which also coincide with reads, except for the final pulse ending at Tₘₐₓ where there is no follow-up read. Thus, the first pulse is of duration T₁, the second pulse of duration T₂−T₁, and so forth. Assume that Tₘₐₓ is determined, as above, via Tₘₐₓ=p_{b}⁻¹(p) for some desired raw bit-error rate p_{b}=p. Further assume that a READ operation takes time tᵣ. Therefore, the total expected time penalty for pulsing and reading can be expressed as

$${T}_{avg} ( {T}_{max} , n , {T}_{1} , … , {T}_{n - 1} ) = Pr ( {T}_{sw} > {T}_{n - 1} ) [ {T}_{max} + ( n - 1 ) {t}_{r} ] + {\sum }_{i = 1}^{n - 1} Pr ( {T}_{i - 1} < {T}_{sw} \leq {T}_{i} ) [ {T}_{i} + {it}_{p} ]$$

where T₀=0 and T_{w} is the random amount of aggregate pulse duration needed to switch. Consider

$${T}^{*} = {min}_{n , 0 < {T}_{1} < … < {T}_{n - 1} < {T}_{max}} {T}_{avg} ( {T}_{max} , n , {T}_{1} , … , {T}_{n - 1} )$$

the minimum average pulse and verification time over all possible pulse end times and number of pulses.

The Tᵢ are constrained to be some positive integer multiple of a small time interval t=Tₘₐₓ/mₘₐₓ, as in Tᵢ=mᵢt, and optimized over the mᵢ. The maximum number of pulses is then Tₘₐₓ/t=mₘₐₓ. Let \hat{T}′ denote the resulting optimum T_{avg} under this constraint on the pulse ending times. Clearly, \hat{T}′≧T′, and it can be shown that

\hat{T}′≦T′+t.

Given an unconstrained set of pulse end times T₁, . . . , Tₙ₋₁, let T={┌Tᵢ/t┐t:i ∈ {1, . . . , n−1}} be the set of quantized end times and \hat{T}₁< . . . <\hat{T}_{\hat{n}-1} be the elements of T smaller than Tₘₐₓ. This construction implies that

\hat{n}≦n

Tᵢ>\hat{T}ⱼ implies i>j

Comparing T_{avg}(Tₘₐₓ,n,T₁, . . . ,Tₙ₋₁) and T_{avg}(Tₘₐₓ,\hat{n},\hat{T}₁, . . . ,\hat{T}_{\hat{n}-1}),T_{avg}(Tₘₐₓ,n,T₁, . . . ,Tₙ₋₁) can be interpreted as the expectation of random variable ƒ(T_{sw}) where ƒ(x) is

$$f ( x ) = 1 ( x > {T}_{n - 1} ) [ {T}_{max} + ( n - 1 ) {t}_{r} ] + {\sum }_{i = 1}^{n - 1} 1 ( {T}_{i - 1} < x \leq {T}_{i} ) [ {T}_{i} + {it}_{r} ]$$

and similarly interpret T_{avg}(Tₘₐₓ,\hat{n},\hat{T}₁, . . . ,\hat{T}_{\hat{n}-1}) as the expectation of the random variable g(T_{sw}) with g(x) as

$$g ( x ) = 1 ( x > {\hat{T}}_{\hat{n} - 1} ) [ {T}_{max} + ( \hat{n} - 1 ) {t}_{r} ] + {\sum }_{j = 1}^{\hat{n} - 1} 1 ( {\hat{T}}_{j - 1} < x \leq {\hat{T}}_{i} ) [ {\hat{T}}_{i} + {it}_{r} ]$$

For any 0≦x≦Tₘₐₓ, g(x)<ƒ(x)+t, which, by way of the expectation interpretation, suffices to establish \hat{T}′≦T′+t. Suppose \hat{T}ⱼ₋₁<x≦\hat{T}ⱼ<Tₘₐₓ, then g(x)=\hat{T}ⱼ+jtᵣ. There will be some i such that Tᵢ₋₁<x≦Tᵢ, where \hat{T}₀=T₀=0 and \hat{T}_{\hat{n}}=Tₙ=Tₘₐₓ. Thus Tᵢ≧x>\hat{T}ⱼ₋₁, and it then follows from Tᵢ>\hat{T}ᵢ implies i>j that i>j−1 or i≧j. Additionally, it is be the case that Tᵢ>\hat{T}ⱼ−t, since otherwise ┌Tᵢ/t┐t would not be in the set of quantized end times T defined above. Putting these two facts together

ƒ(x)=Tᵢ+itᵣ

>\hat{T}ⱼ−t+jtᵣ

=g(x)−t

establishing that indeed g(x)<ƒ(x)+t, for x≦\hat{T}_{\hat{n}-1}. Nearly the same argument can be applied for x>\hat{T}_{\hat{n}-1}.
Thus, a goal is to compute

$${\hat{T}}^{*} = {min}_{n , 0 < {T}_{1} < … < {T}_{n - 1} < {T}_{max}} {T}_{avg} ( {T}_{max} , n , {m}_{1} , … , {m}_{n - 1} t ) .$$

The standard approach to such a computation is dynamic programming. For any 0≦m≦mₘₐₓ and m=m₀<m₁< . . . <mₙ₋₁<mₘₐₓ, define

$${T}_{avg} ( m , n , {m}_{1} , … , {m}_{n - 1} ) = \frac{Pr ( {T}_{sw} > {m}_{n - 1} t )}{Pr ( {T}_{xw} > tm )} [ {T}_{max} - tm + ( n - 1 ) {t}_{r} ] + {\sum }_{t = 1}^{n - 1} \frac{Pr ( {m}_{i - 1} t < {T}_{xw} \leq {m}_{i} t )}{Pr ( {T}_{sw} > tm )} [ ( {m}_{i} - m ) t + {it}_{r} ]$$

which corresponds to the average remaining write time assuming a new pulse starts at mt, with subsequent pulse ending times {mᵢt}, and assuming no switch occurred prior to time mt.
Then define

$${\hat{T}}^{*} ( m ) = {min}_{n , m < {m}_{1} , … , {m}_{n - 1} < {m}_{max}} {T}_{avg} ( m , n , {m}_{1} , … , {m}_{n - 1} ) ,$$

as the best choice of pulse ending times subsequent to pulse time mt, assuming a pulse starts at mt.

Clearly \hat{T}′=\hat{T}′(0). Dynamic programming involves computing \hat{T}′(m) recursively, based on \hat{T}′(m′) for m′>m. Note that for m=mₘₐₓ−1 there is precisely one possible pulse end time, namely the one ending at mₘₐₓt, so that

\hat{T}′(mₘₐₓ−1)=t.

For m<mₘₐₓ−1, one can use a single pulse ending at mₘₐₓt, in which case

T_{avg}(m,1)=(mₘₐₓ−m)t,

or one can use n≧2 pulses ending at intermediate times. For this case, it turns out that

$${min}_{n \geq 2 , m < {m}_{1} < … < {m}_{n - 1} < {m}_{max}} {T}_{avg} ( m , n , {m}_{1} , … , {m}_{n - 1} ) = {min}_{m < {m}_{1} < {m}_{max}} {m}_{1} t - mt + {t}_{r} + \frac{Pr ( {T}_{sw} > {m}_{1} t )}{Pr ( {T}_{sw} > mt )} {T}^{*} ( {m}_{1} ) .$$

This is shown as follows

$${min}_{n \geq 2 , m < {m}_{1} < … < {m}_{n - 1} < {m}_{max}} {T}_{avg} ( m , n , {m}_{1} , … , {m}_{n - 1} ) = {min}_{m < {m}_{1} < {m}_{max}} {min}_{{m < 2 , {m}_{2} < … < {m}_{max}}_{{m}_{2} < {m}_{1}}} {T}_{avg} ( m , {m}_{1} , … , {m}_{n - 1} ) = {min}_{m < {m}_{1} < {m}_{max}} {min}_{{n \geq 2 , {m}_{2} < … < {m}_{max}}_{{\hat{m}}_{2} > {m}_{1}}} \frac{Pr ( {T}_{sw} > {m}_{n - 1} {t}_{r} )}{Pr ( {T}_{sw} > mt )} [ {T}_{max} - mt + ( n - 1 ) {t}_{r} ] + {\sum }_{i = 1}^{n - 1} \frac{Pr ( {m}_{i - 1} t < {T}_{sw} \leq {m}_{i} t )}{Pr ( {T}_{sw} > mt )} [ ( {m}_{i} - m ) t + {it}_{r} ] = {min}_{m < {m}_{1} < {m}_{max}} {min}_{{n \geq 2 , {m}_{2} < … < {m}_{max}}_{{m}_{2} > {m}_{1}}} {m}_{1} t - mt + {t}_{r} + \frac{Pr ( {T}_{sw} > {m}_{n - 1} t )}{Pr ( {T}_{sw} > mt )} [ {T}_{max} - {m}_{1} t + ( n - 2 ) {t}_{r} ] + {\sum }_{i = 2}^{n - 1} \frac{Pr ( {m}_{i - 1} t < {T}_{sw} \leq {m}_{i} t )}{Pr ( {T}_{sw} > mt )} [ ( {m}_{i} - {m}_{1} ) t + ( i - 1 ) {t}_{r} ] = {min}_{m < {m}_{1} < {m}_{max}} {m}_{1} t - mt + {t}_{r} + {min}_{{n \geq 2 , {m}_{2} < … < {m}_{max}}_{{m}_{2} > {m}_{1}}} \frac{Pr ( {T}_{sw} > {m}_{1} t )}{Pr ( {T}_{xw} > mt )} ( \frac{Pr ( {T}_{xw} > {m}_{n - 1} t )}{Pr ( {T}_{xw} > {m}_{1} t )} [ {T}_{max} - {m}_{1} t + ( n - 2 ) {t}_{r} ] + {\sum }_{i = 2}^{n - 1} \frac{Pr ( {m}_{i - 1} t < {T}_{sw} \leq {m}_{i} t )}{Pr ( {T}_{sw} > {m}_{1} t )} [ ( {m}_{i} - {m}_{1} ) t + ( i - 1 ) {t}_{r} ] ) = {min}_{m < {m}_{1} < {m}_{max}} {m}_{1} t - mt + {t}_{r} + \frac{Pr ( {T}_{sw} > {m}_{1} t )}{Pr ( {T}_{sw} > mt )} {T}^{*} ( {m}_{1} ) .$$

Combining T_{avg}(m,1)=(mₘₐₓ−m)t and the initially provided expressions for

$${min}_{n \geq 2 , m < {m}_{1} < … < {m}_{n - 1} < {m}_{max}} {T}_{avg} ( m , n , {m}_{1} , … , {m}_{n - 1} )$$

$$gives$$

$${\hat{T}}^{*} ( m ) = min \{ ( {m}_{max} - m ) t , {min}_{m < {m}_{1} < {m}_{max}} {m}_{1} t - mt + {t}_{r} + \frac{Pr ( {t}_{xw} > {m}_{1} t )}{Pr ( {T}_{sw} > mt )} {T}^{*} ( {m}_{1} ) \} .$$

Thus, one can compute \hat{T}′(m) from \hat{T}′(m′) for m′>m, all the way down to M=0. The optimizing pulse end times can be found by keeping track of the optimizing m₁ for each m, where the optimizing m₁ can be taken to be mₘₐₓ if the outer minimum is achieved by the first term, corresponding to one pulse ending at Tₘₐₓ.

The complexity of the algorithm is readily seen to be no worse than O(mₘₐₓ²) operations. A simple way to dramatically speed up the computation of the minimization over m₁, relative to a full search, is to compute the running minimum for each successively larger value of m₁, starting with m₁=m+1, and abort the search when m₁ is such that m₁t−mt+tᵣ exceeds the running minimum. Since m₁t−mt+tᵣ is increasing in m₁ and since the other component of the cost is always non-negative, aborting in this manner preserves optimally.

### Results of the Analysis of the Various WRITE Methods

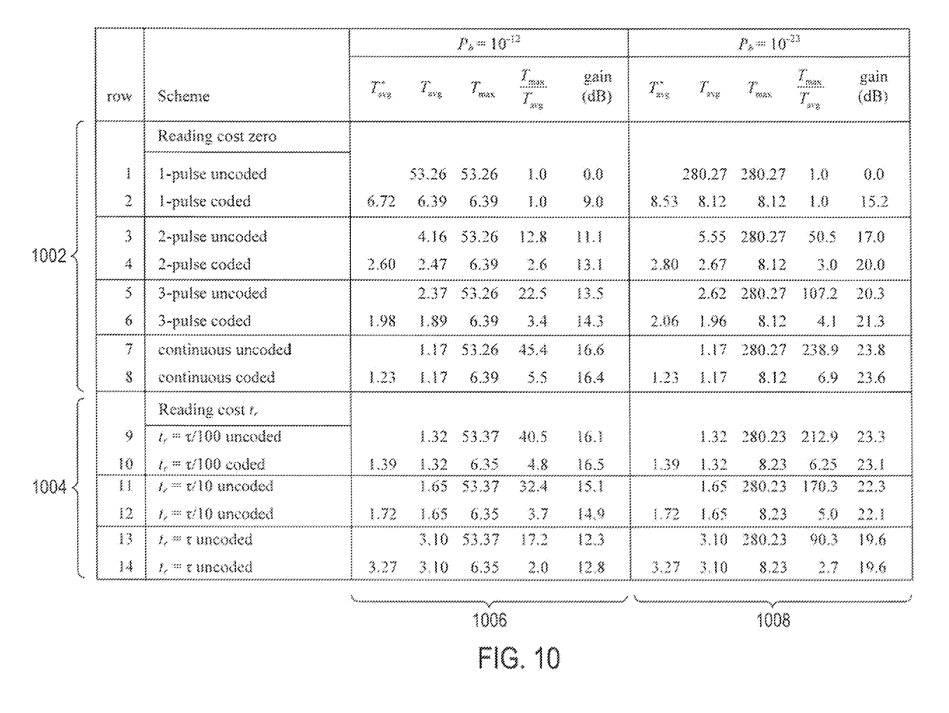

FIG. 10 provides a table showing comparisons of a number of different WRITE methods for writing data into a memory that includes memory elements characterized by log-normally distributed switching times. The table is horizontally divided into two horizontal sections 1002 and 1004, with horizontal section 1002 showing calculated characteristics for various WRITE methods in which the reading cost for methods that incorporate monitoring of feedback signals from memory elements is not considered and with horizontal section 1004 showing calculated characteristics for multi-pulse WRITE methods in which the reading costs are estimated and included in the calculations of the characteristics of the various WRITE methods. The table shown in FIG. 10 is vertically divided into two vertical sections, including a first vertical section 1006 in which the characteristics are calculated to ensure a switching-failure probability P_{b}=10⁻¹² and a second vertical section 1008 in which the characteristics are calculated to ensure a switching-failure probability P_{b}=10⁻²³. In each vertical section of each horizontal section, or, in other words, each quadrant of the table,

$${T}_{avg}^{*} , {T}_{avg} , {T}_{max} , \frac{{T}_{max}}{{T}_{avg}} ,$$

and gain are shown for each of the considered WRITE methods, with T′_{avg} explicitly shown for coded methods. The second horizontal section 1004, shows the characteristics obtained for multi-pulse WRITE methods with a specified Tₘₐₓ and with the cost for reads between pulses equal to various tractions of τ.

As can be seen by analysis of the data shown in the table provided in FIG. 10, the gain G for coded WRITE methods is generally greater than for uncoded WRITE methods and the average or expected pulse time T_{avg} is generally less for coded methods than encoded methods. The Tₘₐₓ voltage-application time for coded methods is significantly less than Tₘₐₓ for encoded methods, in all cases. The decrease in Tₘₐₓ for coded methods versus uncoiled methods occurs even when the reading costs are considered in the calculations. Furthermore, the gains for multi-pulse methods which employ feedback are significantly greater than for the one-pulse coded method.

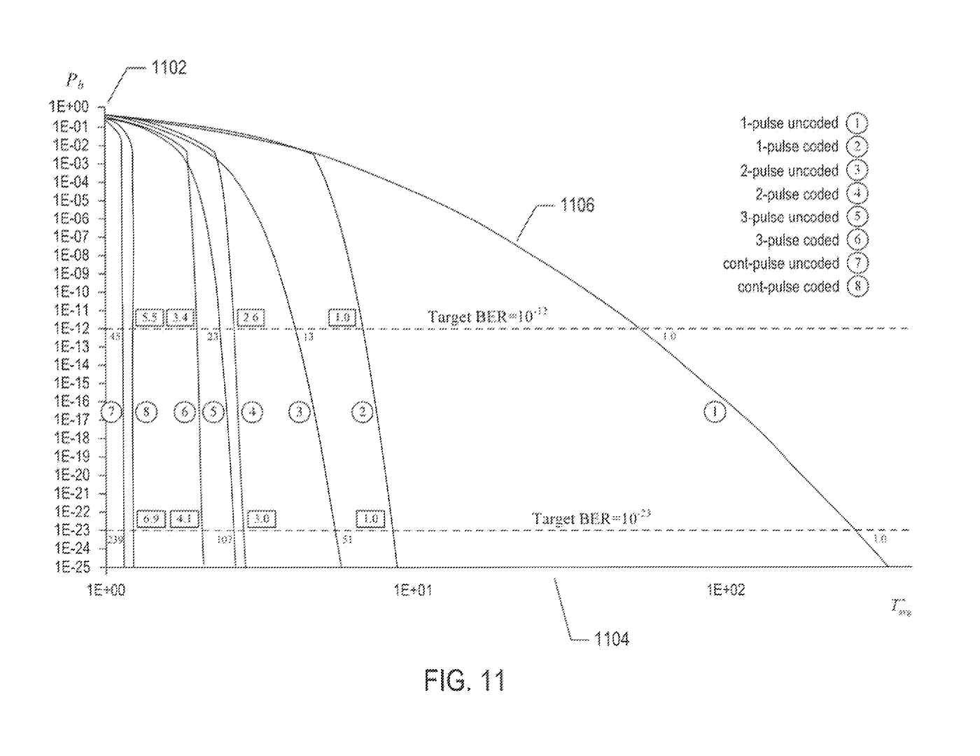

FIG. 11 graphically illustrates data from the first horizontal section of the table provided in FIG. 10. In FIG. 11, the switching-failure probability is plotted with respect to the vertical axis 1102 and the expected pulse time per bit, T′_{avg} is plotted with respect to the horizontal axis 1104. Each curve, such as curve 1106, illustrates the functional relationship between switching failure probability and T′_{avg} for each of eight different WRITE methods. T′_{avg} seen to significantly decrease with increase in the number of pulses employed and the T′_{avg} value for coded methods is generally less than for encoded methods.

At P_{b}=10⁻²³, the coded 2-pulse method offers 3 dB of additional gain over the uncoded 2-pulse method and, more notably, coding reduces the worst-case-to-average ratio from about 50:1 to 3:1, In fact, the 2-pulse encoded method has a gain of just 1.8 dB over the 1-pulse coded one. When comparing the 3-pulse uncoded and coded methods, coding offers additional gains in expected total pulse length (1 dB at P_{b}10⁻²³) and large decreases in worst-case to average ratios. In fact, as shown in FIG. 11, the 3-pulse uncoded curve is very close to the 2-pulse coded curve for the ranges of P_{b} of interest, with the 3-pulse uncoded method incurring a 107:1 worst-case-to-average ratio at P_{b}=10⁻²³ versus a 3:1 ratio for the 2-pulse coded method. For the continuous WRITE methods, the effect of the fast convergence to the mean of the log-normal density f_{τ,σ} can be seen in FIG. 11, where the curves for the continuous WRITE methods are seen to fall practically with vertical slope, at T′_{avg}= T̅ in the uncoded case ( T̅≈1.173τ for the parameter σ₁ used in the examples), and T′_{avg}= T̅/R≈1.05 T̅ for the coded method. Consequently, the average pulse length is practically independent of the target BER, and the difference in coding gain between the uncoded and coded methods in this case is −10 log₁₀R≈0.2 dB in favor of the uncoded. Still, the coded method offers, again, a large decrease in worst-case-to-average ratio: from 239:1 in the uncoded case to 6.9:1 in the coded one, at P_{b}10⁻²³.

Using continuous feedback offers an additional coding gain of approximately 2.3 dB over the 3-pulse coded method (a ratio of 1.7:1 in average pulse length). In principle, this gap could be narrowed in a discrete pulse setting by arbitrarily increasing the number of pulses. In fact, the continuous pulse case can be seen as the limit of the discrete pulse case as the number of pulses tends to infinity.

To summarize, the effects and interactions of two mechanisms aimed at addressing the challenges posed by the log-normal switching behavior of certain memristor devices have been analyzed. In various settings, the use of coding significantly increases the overall performance of the system, by reducing average and worst-case switching times. These performance increases translate into savings in energy consumption and device wear, as well as significant increases in writing throughput. With a judicious combination of a feedback mechanism and error-correction coding, the log-normal switching behavior of memristors should not be an obstacle to meeting the reliability specifications of modern storage systems.

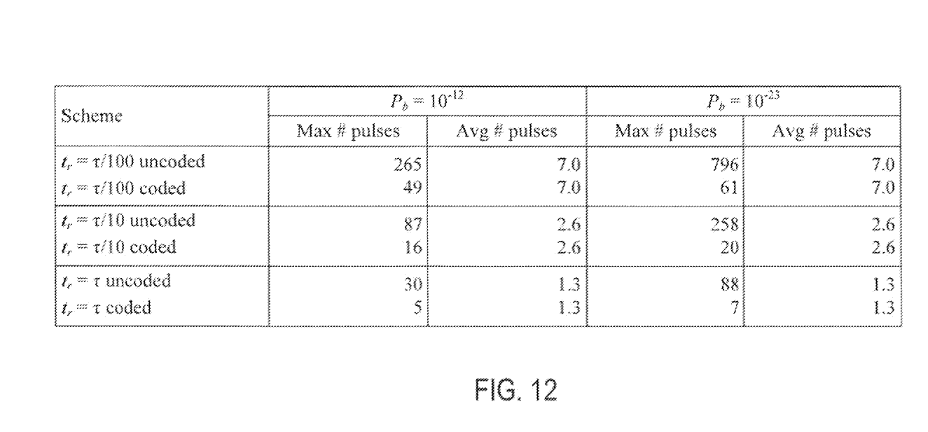

FIG. 12 provides a table that lists the maximum number of pulses and average number of pulses for multi-pulse WRITE methods that achieve desired switching-failure probabilities for considered READ times that are various different fractions of τ. As can be seen in the table provided in FIG. 12, the maximum number of pulses is significantly smaller for coded methods than uncoded methods.

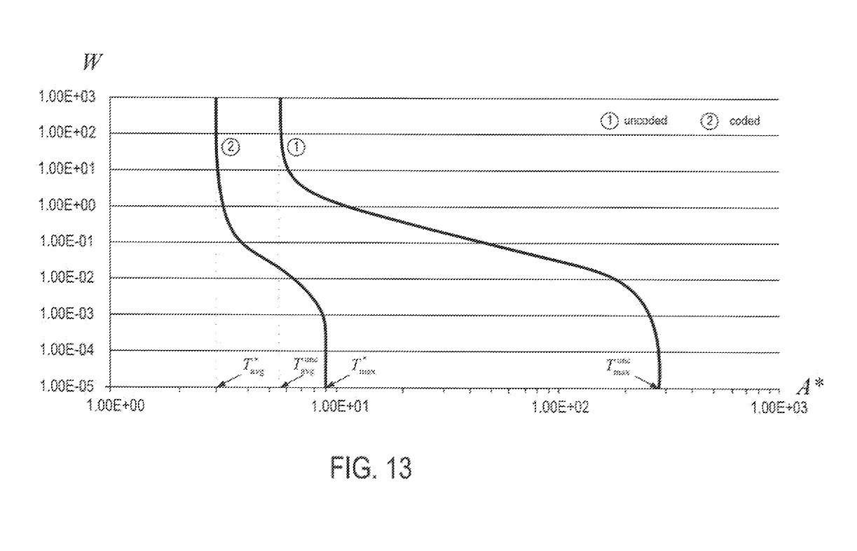

FIG. 13 shows a graph of expected wait times with respect to WRITE inter-arrival times for an uncoded, two-pulse write method and a coded two-pulse WRITE method. As can be seen in FIG. 13, the expected wait times for the coded two-pulse WRITE method are significantly smaller than the expected wait times for uncoded two-pulse methods for all WRITE inter-arrival times. The coding overhead is incorporated into A′=A/R for the coded method, while A′=A for the uncoded method, which allows for a fair comparison between the two methods; the times Tₘₐₓ and T_{avg} are also similarly scaled. Information write throughput is proportional to 1/A′. The positive impact of coding on this throughput is evident in the figure, both without a queueing system (A′=T′ₘₐₓ) and with one (T′_{avg}<A′<T′ₘₐₓ). When queueing is used, the expectation E[Q] provides guidance for the design of an appropriate buffer for WRITE requests.

### Examples of Electronic Data-Storage Devices to which the Current Application is Directed

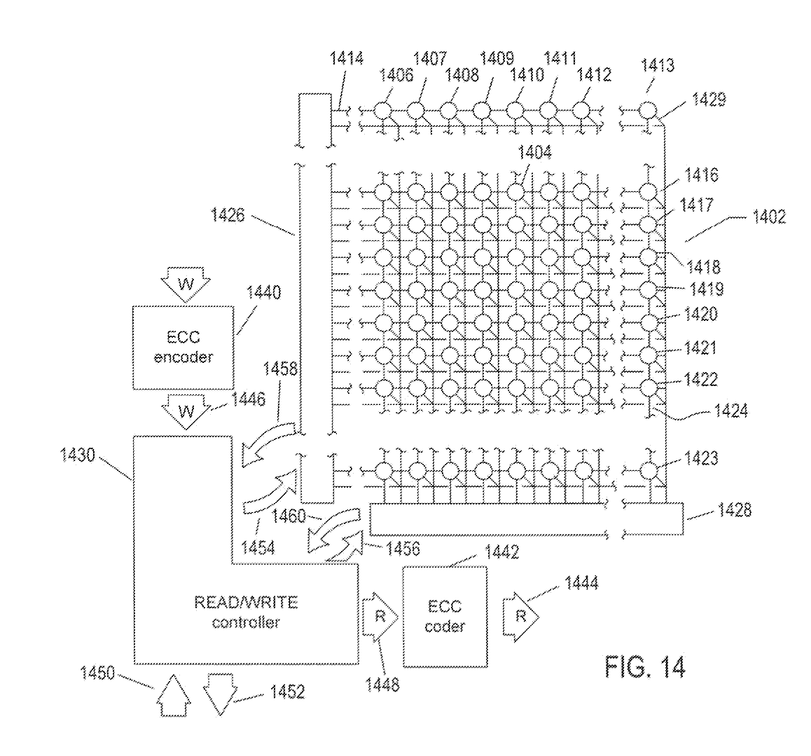

FIG. 14 illustrates a data-storage device that incorporates both feedback signals and ECC encoding. By using both feedback signals and by encoding data prior to writing, the maximum WRITE latency Tₘₐₓ is significantly decreased with respect to the Tₘₐₓ when ECC encoding is not employed, as discussed above, shown by data provided in FIG. 10 and illustrated in FIG. 11. The decrease in maximum WRITE latency and decrease in T_{avg} leads to shorter average and maximum WRITE cycles for the data-storage device and correspondingly higher data-input bandwidth. The feedback signals allow application of a WRITE voltage or other force or gradient needed to switch particular memory elements within the memory to be terminated, or short circuited, as soon as switching is complete for all intended memory elements. Use of ECC encoding allows the maximum duration of WRITE-voltage application, or the duration of application of another force or gradient to switch memory elements, to be significantly decreased and yet still, provide desired bit-error rates for the data-storage device. Shortening Tₘₐₓ moves Tₘₐₓ leftward, along the horizontal axis of the PDF, in FIG. 3A, leaving more area within the tail of the PDF past the Tₘₐₓ that corresponds to the probability that switching does not occur during application of a WRITE voltage for a duration up to Tₘₐₓ. However, use of ECC encoding allows many of the switching errors to be subsequently corrected, following READ operations, effectively decreasing the tail area back to a level corresponding to the desired bit-error rate.

The information-storage device, that represents one example, includes one or more two-dimensional arrays of memory elements 1402. In FIG. 14, each memory element is represented by a disk, such as disk 1404. The memory elements are arranged into rows and columns, and the memory elements within a row are interconnected by a horizontal electrode and the memory elements in each column are interconnected by a vertical electrode or signal line. For example, in FIG. 14, memory elements 1406-1413 are interconnected by horizontal signal line 1414. Memory elements 1413 and 1416-1423 are interconnected by vertical signal line 1424. A first demultiplexer or other control element 1426 controls voltages applied to the horizontal signal lines and a second demultiplexer or other control element 1428 controls voltages applied to the vertical signal lines.

Each memory element also generates a feedback signal, as discussed above with reference to FIG. 4, which is output to both horizontal and vertical feedback signal lines. In FIG. 14, the feedback signals that are generated by memory elements are shown as a diagonal line segments, such as diagonal line segment 1429 emanating from memory element 1413. The first and second controllers 1426 and 1428 monitor these feedback signals, during WRITE operations, in order to generate WRITE-completion signals returned to the READ/WRITE controller. When a data-storage-unit address is supplied, by the READ/WRITE controller 1430, to the first and second control elements 1426 and 1428, along with a data-storage-unit's worth of data to be written to the data-storage device, the first and second controllers 1426 and 1428 apply appropriate voltages to particular signal lines in order to place the memory elements corresponding to the address data-storage unit into states corresponding to the bit values within the data to be written to the data-storage device. Data to be written to the device is supplied first to an ECC encoder 1440 which encodes the data, as discussed above, to a series of codewords which are then transmitted to the READ/WRITE controller 1430. The READ/WRITE controller not only controls the first and second controllers 1426 and 1428 to write data to the data-storage device, but also controls the first and second controllers 1426 and 1428 to read stored data from the data-storage device and transmit the read data to an ECC decoder 1442 which decodes the codewords read from the data-storage device and outputs uncoded data 1444. The READ/WRITE controller 1430 receives data 1446 and outputs data 1448, receives control signals 1450 and outputs non-data information 1452, outputs data and control signals 1454 and 1456 to the first and second controllers 1426 and 1428, respectively, and receives data and control signals 1458 and 1460 from the first and second controllers 1426 and 1428, respectively.

In an alternative example, either the first, and second controllers or the READ/WRITE controller iteratively WRITE data to memory elements using the above-described multi-pulse method, reading back the data to determine where or not the WRITE has succeeded. In this alternative example, the memory elements do not generate feedback signals. Instead, the first and second controllers 1426 and 1428 apply multiple WRITE pulses to memory elements, reading the contents of the memory elements to which the pulses are applied after each pulse, in order to determine whether or not the data has been correctly written. Based on the multiple-pulse WRITE and intervening READ operations used to verify correct data storage, the first and second controllers generate WRITE-completion signals returned to the READ/WRITE controller, as in the first-described example in which the state or memory elements is continuously monitored.

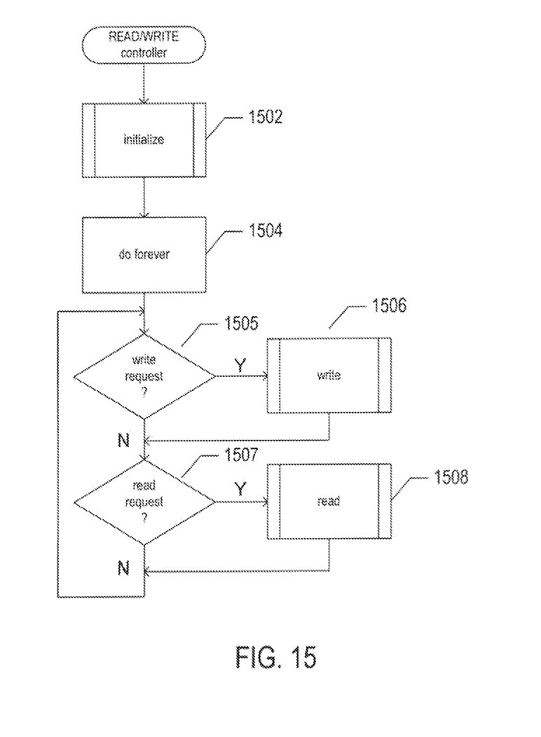

FIG. 15 provides a control-flow diagram that illustrates operation of the READ/WRITE controller (1430 in FIG. 14). In step 1502, the READ/WRITE controller is initialized, upon power-up or reset. Then, the READ/WRITE controller enters a continuous loop comprising steps 1504-1508. The READ/WRITE controller continuously monitors inputs for input WRITE requests and corresponding data and input READ requests. When a WRITE request is detected, in step 1505, the READ/WRITE controller undertakes one or more WRITE operations via the routine “Write” 1506. Similarly, when READ requests are received, as determined in step 1507, the READ requests are processed via the routine “Read” 1508.

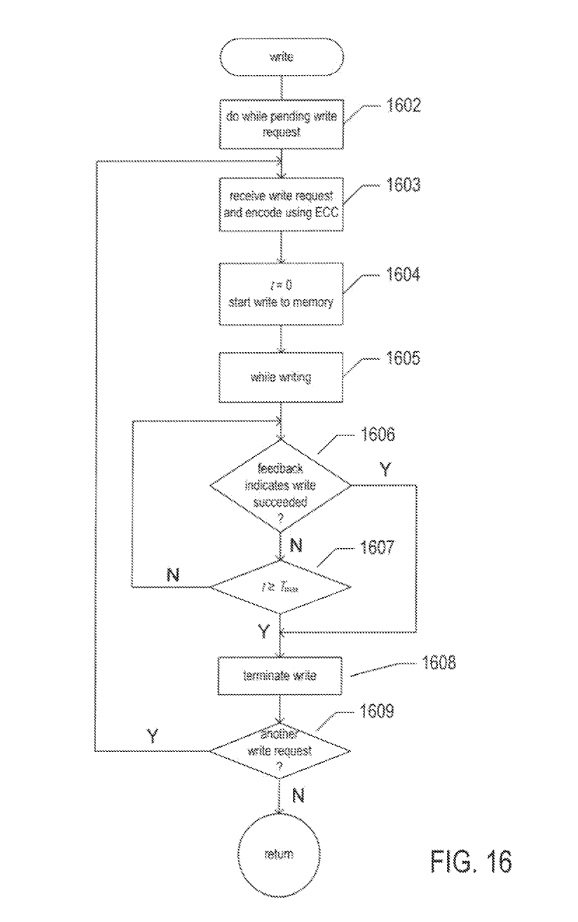

FIG. 16 provides a control-flow diagram for the routine “write” (1506 in FIG. 15). The routine “write” comprises a continuous loop including steps 1002-1609, the continuous loop including an inner loop comprising steps 1605-1607. In the outer continuous loop of steps 1602-1009, pending WRITE requests are processed, one WRITE request at a time. In step 1603, a next WRITE request is received. The data associated with the WRITE request is broken into chunks of k bits and each chunk is encoded using an ECC to generate corresponding codewords for the chunks. Then, in step 1604, a timer t is initialized and the READ/WRITE controller transmits the codewords and control signals to the first and second controllers (1426 and 1428 in FIG. 14) to begin applying WRITE voltages to selected memory elements in order to write the codewords into one or more two-dimensional arrays of memory elements. In FIG. 16, the data for a WRITE request is written, in parallel to corresponding memory elements by the first and second controllers. In certain examples, WRITE requests may contain a greater amount of data than can be written in a single parallel WRITE operation, in which case additional logic, corresponding in FIG. 16 to an additional iterative loop, would be used to carry out two or more WRITE operations needed to write all of the data associated, with a single WRITE request to corresponding memory elements. In certain, alternative examples, memory cells may be written sequentially, rather in parallel. In the inner loop of steps 1605-1607, the READ/WRITE controller monitors feedback signals produced by the memory elements as well as the timer. When all of the feedback signals for all memory elements involved in the WRITE operation indicate that the WRITE operation has succeeded, as determined in step 1006, then control flows to step 1608, where the WRITE operation is terminated. Otherwise, when the timer indicates that the WRITE voltage has been applied for a duration equal to or greater than Tₘₐₓ, as determined in step 1607, then control flows to the WRITE termination step 1608. Otherwise, monitoring continues. Once the WRITE has terminated, then, in step 1609, when another WRITE operation is pending, control is directed back to step 1603. Otherwise, the routine “Write” terminates. As discussed above, the fact that ECC encoding and decoding is employed, a certain rate of WRITE failures can be tolerated without resulting in return of corrupted data by the data-storage device. Use of ECC data encoding and decoding within the data-storage device allows use of a smaller-magnitude Tₘₐₓ than would be used, without ECC data encoding and decoding, to achieve an acceptable BER.

FIG. 16 provides a general description of the continuous WRITE methods in which the state of memory elements is continuously monitored. In the above-discussed alternative example, in which multi-pulse WRITE methods are employed, the inner loop of steps 1605-1607 would iterate until a WRITE-complete signal is received from the READ/WRITE controller, whether or not the WRITE succeeded. As discussed above, the number of pulses and other pulse characteristics are selected is order to provide a BER that, following ECC decoding, is at or below a maximum acceptable BER. In general, the READ/WRITE controller may be implemented to buffer data for large WRITE requests and execute the large WRITE requests in a series of internal WRITE requests, each involving a number of codewords that can be received and written to memory elements by the first and second controllers during a single internal WRITE operation. Alternatively, the data-storage device may accept up to an amount of data for each external WRITE operation than can be written to memory elements in a single operation. The first and second controllers, in general, control storage to multiple memory elements, in parallel, during an internal WRITE operation. The feedback signal generated by the first and second controllers indicates whether or not all memory elements involved in an internal WRITE operation have been successfully carried out. The first and second controllers may apply WRITE voltages for different periods of time to individual memory elements, or may apply a different number of pulses to individual memory elements, during an internal WRITE operation.

Although the present disclosure has been described in terms of particular examples, it is not intended that the disclosure be limited to these examples. Modifications within the spirit of the disclosure will be apparent to those skilled in the art. For example, the use of both feedback signals and ECC encoding can be employed in a wide variety of different types of information-storage devices that include memory elements with asymmetrical switching-time PDFs, including memristive memory elements, phase-change memory elements, and other types of memory elements. The particular ECC code employed and the particular values of Tₘₐₓ employed within the information-storage devices can be set to various different codes and calculated values, respectively, in order to ensure bit-error rates for the information-storage devices that meet or fall below specified maximum bit-error-rates. In certain types of information-storage devices, the maximum WRITE-voltage application time Tₘₐₓ and the ECC codes used for encoding the data can be controlled or reset dynamically, depending on dynamically determined maximum BERs, the age of the information-storage device, particularly the ages of the memory elements, the total number of READ/WRITE cycles carried out on the information-storage device, and other such characteristics and parameters.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

1. A data-storage device comprising:
one or more arrays of memory elements that each includes
a data-storage medium that is switched between at least two different states by application of a switching-inducing force or gradient to the data-storage medium,
a top control element and a bottom control element through which the switching-inducing force or gradient is applied, and
a feedback signal;
an error-control-coding encoder that encodes received data; and
a READ/WRITE controller that writes encoded data received from the error-control-coding encoder to a number of memory elements by applying the switching-inducing force or gradient to the one or more arrays of memory elements until feedback signals indicate that the WRITE operation has completed or until the switching-inducing force or gradient has been applied for a maximum application time.

2. The data-storage device of claim 1 wherein the memory elements are characterized by log-normality-distributed switching times.

3. The data-storage device of claim 1 wherein the maximum application time is shorter than a time that would provide a specified bit error rate for uncoded WRITE operations.

4. The data-storage device of claim 3 further including an error-control-coding decoder that decodes data read from the one or more arrays of memory elements by the READ/WRITE controller

5. The data-storage device of claim 1 wherein the data-storage medium is a memristive material that switches between a first resistivity state and a second resistivity state when a switching-inducing voltage is applied across the data-storage medium.

6. A method for writing data to a data-storage device that includes one or more arrays of memory elements, each including a material that is switched between, at least two different states by application of a switching-inducing force or gradient to the material, a top control element and a bottom control element through which the switching-inducing force or gradient is applied, and a feedback signal, the method comprising:
encoding the data by an error-control-coding encoder; and
writing the encoded data to a number of memory elements by applying the switching-inducing force or gradient to the one or more arrays of memory elements until feedback signals indicate that the WRITE operation has completed or until the switching-inducing force or gradient has been applied for a maximum application time.

7. The method of claim 6 further including selecting the maximum application time to be shorter than a minimum application time calculated to ensure a specified bit error rate for writing uncoded data to the one or more arrays but sufficiently long that, when the data is subsequently read from the one or more arrays and decoded by an error-control-coding decoder that corrects up to a certain number of bit errors in the data read from the one or more arrays, the overall bit error rate for writing data to, and reading the data back from, the data-storage device is less than or equal to the specified bit error rate.

8. The method of claim 6 wherein the data-storage medium is a memristive material that switches between a first resistivity state and a second resistivity state when a switching-inducing voltage is applied across the data-storage medium

9. The method of claim 6 wherein the memory elements are characterized by log-normally-distributed switching times.

10. The method of claim 6 wherein the switching-inducing force or gradient is applied to the one or more arrays of memory elements continuously while the feedback signals are continuously monitored.

11. The method of claim 6 wherein the switching-inducing force or gradient is applied to the one or more arrays of memory elements during discrete intervals, between which the feedback signals are used to determine whether or not the data has been successfully written.

12. A data-storage device comprising:
one or more arrays of memory elements that each includes
a data-storage medium that is switched between at least two different states by application of a switching-inducing force or gradient to the data-storage medium, and
a top control element and a bottom control element through which the switching-inducing force or gradient is applied;
an error-control-coding encoder that encodes received data; and
a READ/WRITE controller that writes encoded data received from the error-control-coding encoder to a number of memory elements by applying the switching-inducing force or gradient to the one or more arrays of memory elements in multiple pulses, verifying that the WRITE operation has succeeded after each pulse by a READ operation, until the WRITE operation has completed or until a maximum number of pulses have been applied.

13. The data-storage device of claim 1 wherein the memory elements are characterized by log-normally-distributed switching times.

14. The data-storage device of claim 1 wherein the cumulative switching-inducing-force-or-gradient application time, over multiple pulses, is shorter than a time that would provide a specified bit error rate for uncoded WRITE operations.

15. The data-storage device of claim 3 further including an error-control-coding decoder that decodes data read from the one or more arrays of memory elements by the READ/WRITE controller
